(19) United States
(12) Patent Application Publication
(10) Pub. No.: US 2004/0252897 A1
(43) Pub. Date: Dec. 16, 2004

(54) Image processing apparatus and computer-readable storage medium

(76) Inventors: Junichi Hara, Kanagawa (JP); Toshio Miyazawa, Kanagawa (JP); Yasuyuki Nomizu, Kanagawa (JP); Hiroyuki Sakuyama, Tokyo (JP); Nekka Matsuura, Kanagawa (JP); Takanori Yano, Kanagawa (JP); Taku Kodama, Kanagawa (JP); Yasuyuki Shinkai, Kanagawa (JP); Takayuki Nishimura, Tottori (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/769,077

(22) Filed: Jan. 29, 2004

(30) Foreign Application Priority Data
Jan. 31, 2003 (JP) 2003-025137
Jan. 23, 2004 (JP) 2004-015997

(51) Int. Cl. G06K 9/36

(52) U.S. Cl. 382/239

(57) ABSTRACT

An image processing apparatus is provided with a converting unit to subject an image data to a hierarchical two-dimensional wavelet transform, a coding unit to code each of a plurality of sub-bands which are hierarchically generated from the image data by the converting unit, and a code quantity control unit to control, based on a code quantity of a predetermined sub-band, code quantities of other sub-bands.

The present application claims priority to the corresponding Japanese Application Nos. 2003-025137, filed on Jan. 31, 2003 and 2004-015997, filed on Jan. 23, 2004, the entire contents of which are hereby incorporated by reference.

### BACKGROUND OF THE INVENTION

1. Field of the Invention

The present invention generally relates to, and more particularly to image processing apparatuses and computer-readable storage media, and more particularly to an image processing apparatus that controls a code quantity of sub-bands when coding the sub-bands which are generated by subjecting image data to a wavelet transform, and to a computer-readable storage medium which stores a program for causing a computer to perform such code quantity control.

2. Description of the Related Art

Image processing apparatuses such as scanners, digital cameras, monitoring cameras, personal computers, printers, copying machines and composite apparatuses (or MFPs: Multi Function Peripherals), have become very popular. As a result, there are increased opportunities to store digital image data in memories and storage units such as hard disk drives (HDDs) and optical disk drives including CD-ROM drives. Furthermore, digital image data are often transmitted and received via networks such as the Internet. Such digital image data are normally compressed and stored in the memories, the storage units and the like. On the other hand, the computers, composite apparatuses and the like which are provided with the memory or storage unit are often used as image servers.

Recently, it has become possible to simply obtain a high-definition image using various techniques. But since the trend is for the image data size of the high-definition image to increase, it is becoming more and more difficult to process the high-definition image. As one of image compression and expansion algorithms for facilitating the processing of such high-definition still images, the JPEG (Joint Photographic Experts Group) system is popularly used. In addition, a Discrete Wavelet Transform (DWT) has been proposed as a frequency conversion to replace the Discrete Cosine Transform (DCT) that is employed by the JPEG system. The JPEG2000 that has become an international standard in 2001 is a typical image compression and expansion algorithm that employs the DWT.

As described above, the compressed image data is often stored in a recording apparatus. For example, in the case of the digital camera, the image server and the like having the recording apparatus, it is desirable that a large number of images are recordable. For this reason, methods have been proposed to control the image data to a predetermined code quantity, such as a first method proposed in a Japanese Patent No.2,882,663 and a second method proposed in a Japanese Laid-Open Patent Application No.2000-188552. The first method controls the code quantity using a reduced image obtained by image decimation. On the other hand, the second method controls the code quantity by the JPEG2000.

In order to perform an ideal code quantity control, it is effective to perform the code quantity control with respect to the code data (image data) after all of the processes are carried out, but in this case, a large memory capacity and a long processing time are required, thereby making it difficult to employ such a code quantity control in the recording apparatus from the practical point of view. In addition, according to the first method, the processing time is particularly long because of the need to perform the image decimation in order to form the reduced image.

### SUMMARY OF THE INVENTION

An image processing apparatus and computer-readable storage medium are described. In one embodiment, the image processing apparatus comprises: a converting unit to subject an image data to a hierarchical two-dimensional wavelet transform; a coding unit to code each of a plurality of sub-bands which are hierarchically generated from the image data by the converting unit; and a code quantity control unit to control, based on a code quantity of a predetermined sub-band, code quantities of other sub-bands.

### BRIEF DESCRIPTION OF THE DRAWINGS

FIG. 1 is a system block diagram for illustrating the operating principle of the JPEG2000 algorithm;

FIG. 2 is a diagram showing an example of each component of a color image divided into tiles;

FIG. 3 is a diagram showing an example of a sub-band at each decomposition level for a case where the decomposition level is 3;

FIG. 4 is a diagram for illustrating one example of the relationship of a precinct and a code block;

FIG. 5 is a diagram for illustrating the procedure for ordering bit-planes;

FIG. 6 is a simplified diagram showing an example of a code stream structure;

FIG. 7 is a cross sectional view showing a general structure of one embodiment of an image processing apparatus;

FIG. 8 is a system block diagram showing a structure of a control system of the image processing apparatus shown in FIG. 7;

FIG. 9 is a functional block diagram for illustrating an image processing system of the image processing apparatus shown in FIG. 7;

FIG. 10 is a flow chart for illustrating an image processing operation of one embodiment;

FIG. 11 is a diagram showing sub-bands for a case where a decomposition level is 3;

FIG. 12 is a flow chart for illustrating an image processing operation of one embodiment of the image processing apparatus;

FIG. 13 is a flow chart for illustrating an image processing operation of one embodiment of the image processing apparatus;

FIG. 14 is a flow chart for illustrating an image processing operation of one embodiment of the image processing apparatus;

FIG. 15 is a functional block diagram for illustrating an image processing system of one embodiment of the image processing apparatus;

FIG. 16 is a functional block diagram for illustrating an image processing system of one embodiment of the image processing apparatus;

FIG. 17 is a flow chart for illustrating an image processing operation of one embodiment of the image processing apparatus;

FIG. 18 is a flow chart for illustrating an image processing operation of one embodiment of the image processing apparatus;

FIG. 19 is a functional block diagram for illustrating an image processing system of one embodiment of the image processing apparatus; and

FIG. 20 is a functional block diagram for illustrating an image processing system of one embodiment of the image processing apparatus;

### DESCRIPTION OF THE PREFERRED EMBODIMENTS

One or more embodiments of the present invention include a novel and useful image processing apparatus and computer-readable storage medium, in which the problems described above are eliminated.

Other and more specific embodiments of the present invention include an image processing apparatus and a computer-readable storage medium that can perform an accurate code quantity control and reduce the processing time and/or perform the code quantity control by placing priority on the image quality.

Still another and more specific embodiment of the present invention includes an image processing apparatus comprising a converting unit to subject an image data to a hierarchical two-dimensional wavelet transform; a coding unit to code each of a plurality of sub-bands which are hierarchically generated from the image data by the converting unit; and a code quantity control unit to control, based on a code quantity of a predetermined sub-band, code quantities of other sub-bands. According to the image processing apparatus of one embodiment of the present invention, it is possible to perform an accurate code quantity control and to reduce the processing time, because there is no need to perform a decimation process or the like.

A further embodiment of the present invention includes an image processing apparatus comprising converting means for subjecting an image data to a hierarchical two-dimensional wavelet transform; coding means for coding each of a plurality of sub-bands which are hierarchically generated from the image data by the converting unit; and code quantity control means for controlling, based on a code quantity of a predetermined sub-band, code quantities of other sub-bands. According to the image processing apparatus of the present invention, it is possible to perform an accurate code quantity control and to reduce the processing time, because there is no need to perform a decimation process or the like.

Another embodiment of the present invention includes an image processing apparatus comprising a converting unit to subject an image data to a hierarchical two-dimensional wavelet transform; a first coding unit to code each of a plurality of sub-bands which are hierarchically generated from the image data by the converting unit, based on a predetermined code quantity; a code quantity control unit to control, based on a code quantity of an arbitrary sub-band, code quantities of other sub-bands; a second coding unit to code each of the plurality of sub-bands which are hierarchically generated from the image data by the converting unit, based on the code quantity which is controlled by the code quantity control unit; and a switching unit to selectively supply the plurality of sub-bands from the converting unit to one of the first and second coding units. According to the image processing apparatus of one embodiment of the present invention, it is possible to perform the code quantity control by placing priority on the image quality. In other words, it is possible to select the code quantity control that places priority on the image quality or, the code quantity control for the normal image quality.

In the image processing apparatus, the coding unit may code each of the plurality of sub-bands based on a predetermined code quantity control parameter. The code quantity control unit may control the code quantities of the other sub-bands by changing the code quantity control parameter based on the code quantity of the predetermined sub-band. In this case, it is possible to control the code quantity control parameter by a simple operation, and a simple and accurate code quantity control can be realized.

In the image processing apparatus, the code quantity control unit may control a code quantity of a sub-band in a lower layer of a hierarchical structure based on a code quantity of a sub-band in an upper layer of the hierarchical structure. In this case, it is possible to realize a code quantity control that places priority on the image quality.

In the image processing apparatus, the code quantity control unit may control a code quantity of a sub-band in a predetermined layer of a hierarchical structure based on the code quantity of the predetermined sub-band that is also in the predetermined layer of the hierarchical structure. In this case, it is possible to realize an accurate code quantity with a high precision.

The image processing apparatus may further comprise a reading optical system to optically read the image data from a document. In this case, it is possible to subject the read document image to various image processing operations.

The image processing apparatus may further comprise an expanding unit to expand the image data that is coded by a procedure including a decoding and a two-dimensional inverse wavelet transform. In this case, it is possible to expand the compressed image and output the expanded image for display on a display unit, for printing on a recording medium, and the like.

The image processing apparatus may further comprise a printer engine to form an image on a recording medium based on the image data that has been expanded by the expanding unit. In this case, it is possible to print the image on the recording medium such as recording paper based on the expanded image data.

In the image processing apparatus, the code quantity control unit may control the code quantity after the wavelet transform with respect to all layers of the hierarchical structure. In this case, it is possible to perform the code quantity control by placing priority on the image quality.

In the image processing apparatus, the code quantity control unit may control the code quantity after the wavelet transform with respect to each layer of the hierarchical structure. In this case, it is possible to perform the code quantity control by placing priority on the image quality, and to reduce the storage capacity required to store the image data because the bit depth of the wavelet coefficients to be stored is reduced.

Still another embodiment of the present invention comprises an image processing apparatus comprising converting means for subjecting an image data to a hierarchical two-dimensional wavelet transform; first coding means for coding each of a plurality of sub-bands which are hierarchically generated from the image data by the converting unit, based on a predetermined code quantity; code quantity control means for controlling, based on a code quantity of an arbitrary sub-band, code quantities of other sub-bands; second coding means for coding each of the plurality of sub-bands which are hierarchically generated from the image data by the converting unit, based on the code quantity which is controlled by the code quantity control unit; and switching means for selectively supplying the plurality of sub-bands from the converting unit to one of the first and second coding units. According to the image processing apparatus of one embodiment of the present invention, it is possible to perform the code quantity control by placing priority on the image quality. In other words, it is possible to select the code quantity control that places priority on the image quality or, the code quantity control for the normal image quality.

A further embodiment of the present invention comprises a computer-readable storage medium which stores a program for causing a computer to process image data, the program comprising a converting procedure causing the computer to subject an image data to a hierarchical two-dimensional wavelet transform; a coding procedure causing the computer to code each of a plurality of sub-bands which are hierarchically generated from the image data by the converting procedure; and a code quantity control procedure causing the computer to control, based on a code quantity of a predetermined sub-band, code quantities of other sub-bands. According to the computer-readable storage medium of one embodiment of the present invention, it is possible to perform an accurate code quantity control and to reduce the processing time, because there is no need to perform a decimation process or the like.

Another embodiment of the present invention comprises a computer-readable storage medium which stores a program for causing a computer to process image data, the program comprising a converting procedure causing the computer to subject an image data to a hierarchical two-dimensional wavelet transform; a first coding procedure causing the computer to code each of a plurality of sub-bands which are hierarchically generated from the image data by the converting procedure, based on a predetermined code quantity; a code quantity control procedure causing the computer to control, based on a code quantity of an arbitrary sub-band, code quantities of other sub-bands; a second coding procedure causing the computer to code each of the plurality of sub-bands which are hierarchically generated from the image data by the converting procedure, based on the code quantity which is controlled by the code quantity control procedure; and a switching procedure causing the computer to selectively supply the plurality of sub-bands obtained by the converting procedure for use by one of the first and second coding procedures. According to the computer-readable storage medium of one embodiment of the present invention, it is possible to perform the code quantity control by placing priority on the image quality. In other words, it is possible to select the code quantity control that places priority on the image quality or, the code quantity control for the normal image quality.

Other embodiments and further features of the present invention will be apparent from the following detailed description when read in conjunction with the accompanying drawings.

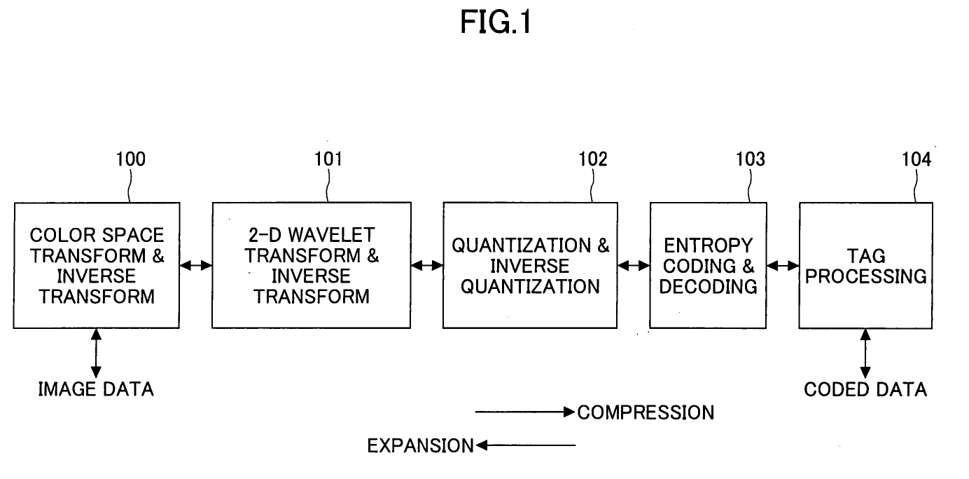

A description will be given of one embodiment of an image processing apparatus according to the present invention, by referring to FIGS. 1 through 11. This embodiment of the image processing apparatus employs an embodiment of a computer-readable storage medium according to the present invention. In this embodiment, the present invention is applied to a composite apparatus. Furthermore, this embodiment utilizes the JPEG2000 algorithm.

A general description will first be given of the JPEG2000 algorithm. A detailed description of the JPEG2000 algorithm will be omitted in this specification, because the JPEG2000 algorithm itself is known.

FIG. 1 is a system block diagram for illustrating the operating principle of the JPEG2000 algorithm. The JPEG2000 algorithm is realized by a color space transform and inverse transform unit 100, a two-dimensional wavelet transform and inverse transform unit 101, a quantization and inverse quantization unit 102, an entropy coding and decoding unit 103, and a tag processing unit 104.

It may be seen from FIG. 1 that the transformation method is one of the largest differences between the JPEG and the JPEG2000. The JPEG system employs a discrete cosine transform (DCT), while the JPEG2000 system employs the discrete wavelet transform (DWT). Compared to the DCT, the DWT has an advantage in that the image quality is good in the high compression region, which is the main reason for employing the DWT in the JPEG2000 system. Another large difference between the JPEG and the JPEG2000 is that the JPEG2000 additionally uses a functional block called the tag processing unit 104 at the last stage for forming codes. The tag processing unit 104 generates the compressed data as a code stream at the time of the compression operation, and interprets the code stream necessary for the expansion at the time of the expansion operation. The JPEG2000 can realize various convenient functions by the code stream.

At the original image input and output units shown in FIG. 1, the color space transform and inverse transform unit 100 is connected in most cases. For example, a transformation from the RGB calorimetric system made up of red (R), green (G) and blue (B) components of the primary color system or, from the YMC colorimetric system made up of yellow (Y), magenta (M) and cyan (C) components of the complementary color system, to the YUV or YCrCb colorimetric system or, an inverse transformation, is carried out in the color space transform and inverse transform unit 100.

Next, a description will be given of the JPEG2000 algorithm. The technical terms related to the JPEG2000 are in conformance with the JPEG2000 Final Draft International Standard (FDIS). Typical technical terms are defined as follows.

1. “Bit-Plane:” A two-dimensional array of bits. In this Recommendation International Standard a bit-plane refers to all the bits of the same magnitude in all coefficients or samples. This could refer to a bit-plane in a component, tile-component, code-block, region of interest, or other.

2. “Code-Block:” A rectangular grouping of coefficients from the same sub-band of a tile-component.

3. “Decomposition Level:” A collection of wavelet sub-bands where each coefficient has the same spatial impact or span with respect to the source component samples. These include the HL, LH, and HH sub-bands of the same two-dimensional sub-band decomposition. For the last decomposition level the LL sub-band is also included.

4. “Layer:” A collection of compressed image data from coding pass of one, or more, code-blocks of a tile-component. Layers have an order for coding and decoding and decoding that must be preserved.

5. “Precinct:” A one rectangular region of a transformed tile-component, within each resolution level, used for limiting the size of packets.

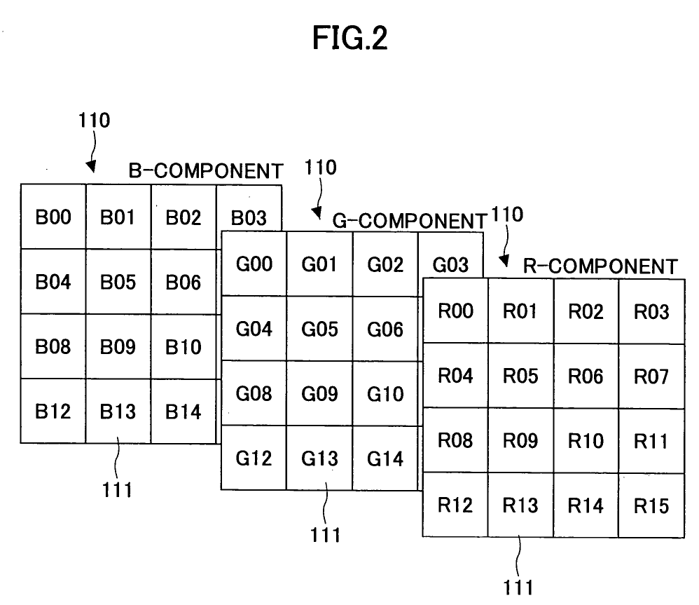

FIG. 2 is a diagram showing an example of each component of a color image divided into tiles. Generally, each of components 110 (RGB primary color system in this case) of the original image is divided into rectangular regions (tiles) 111 in the color image as shown in FIG. 2. Each of the tiles 111, such as R00, R01, . . . , R15, G00, G01, . . . , G15, B00, B01, . . . , B15, becomes a basic unit for executing the compression and expansion process. Accordingly, the compression and expansion operation is independently carried out for every component 110 and for every tile 111.

At the time of the coding, the data of each tile 111 of each component 110 is input to the color space transform and inverse transform unit 100 and subjected to a color space transform, and is thereafter subjected to a two-dimensional wavelet transform (forward transform) in the two-dimensional wavelet transform unit 101 and spatially divided into frequency bands.

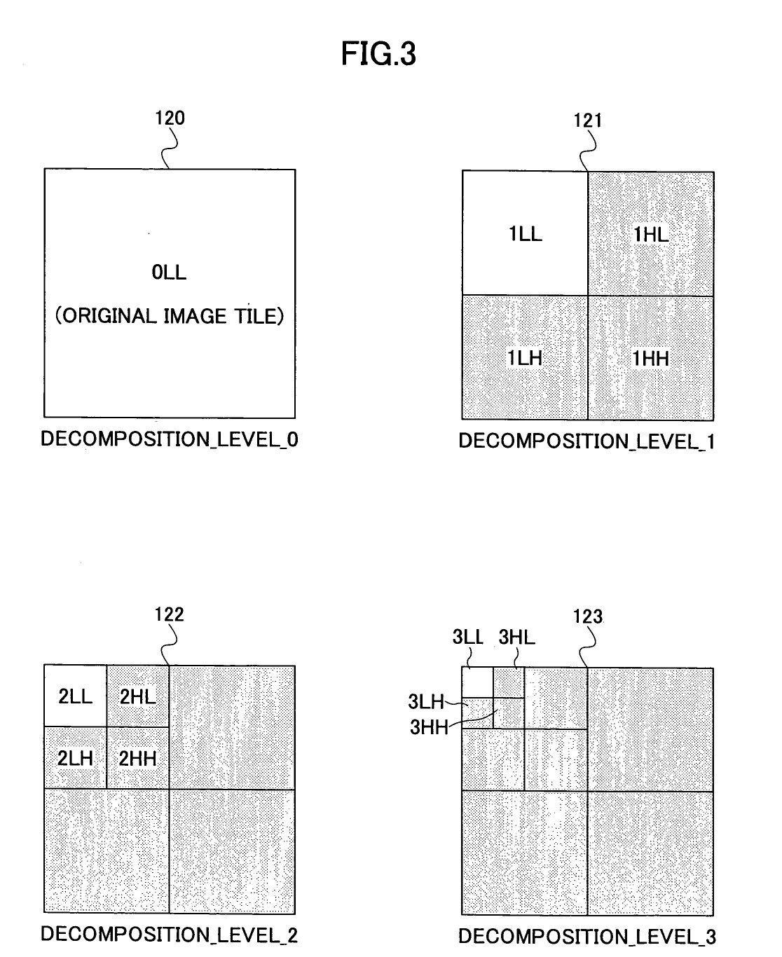

FIG. 3 is a diagram showing an example of a sub-band at each decomposition level for a case where the decomposition level is 3. The two-dimensional wavelet transform is carried out by the two-dimensional wavelet transform unit 101 with respect to the tile original image (0LL) (decomposition level 0 (120)) obtained by the tile-division of the original image, in order to separate the sub-bands (1LL, 1HL, 1LH, 1HH) indicated by the decomposition level 1 (121). The two-dimensional wavelet transform is then carried out with respect to the low-frequency component 1LL at this level, in order to separate the sub-bands (2LL, 2HL, 2LH, 2HH) indicated by the decomposition level 2 (122). Similarly thereafter, the two-dimensional wavelet transform is also carried out with respect to the low-frequency component 2LL, in order to separate the sub-bands (3LL, 3HL, 3LH, 3HH) indicating the decomposition level 3 (123). In FIG. 3, the color of the sub-band that is the target of the coding at each decomposition level is indicated by gray. For example, when the decomposition level is 3, the sub-bands (3HL, 3LH, 3HH, 2HL, 2LH, 2HH, 1HL, 1LH, 1HH) indicated by gray are the coding targets, and the 3LL sub-band is not coded.

Next, the bits that are the coding targets are determined in the specified coding order, and context is generated from the peripheral bits of the target bit in the quantization and inverse quantization unit 102. The wavelet coefficients after the quantization process ends are divided into non-overlapping rectangular regions called precincts, for each of the individual sub-bands. The precincts are introduced to efficiently utilize the memory upon implementation.

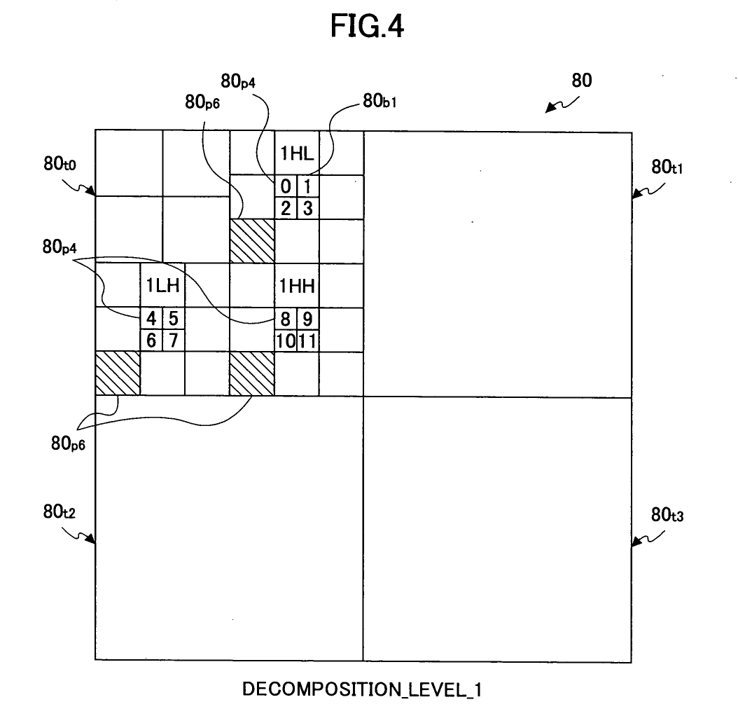

FIG. 4 is a diagram for illustrating one example of the relationship of the precinct and the code block. An original image 80 is divided into 4 tiles 80ₜ₀, 80ₜ₁, 80ₜ₂ and 80ₜ₃ at the decomposition level 1. As shown in FIG. 4, a precinct 80ₚ₄, for example, is made up of 3 spatially matching rectangular regions, and the same holds true for a precinct 80ₚ₆. Furthermore, each precinct is divided into non-overlapping rectangular blocks called code blocks. In this particular example, each precinct is divided into 12 code blocks 0 to 11, and for example, a code block 80_{b1} indicates a code block number 1. The code block becomes a basic unit when carrying out the entropy coding.

The coefficients after the wavelet transform may be quantized and coded as they are. However, in order to improve the coding efficiency, JPEG2000 decomposes the coefficient values into bit-plane units, and the bit-planes may be ordered for every pixel or code block.

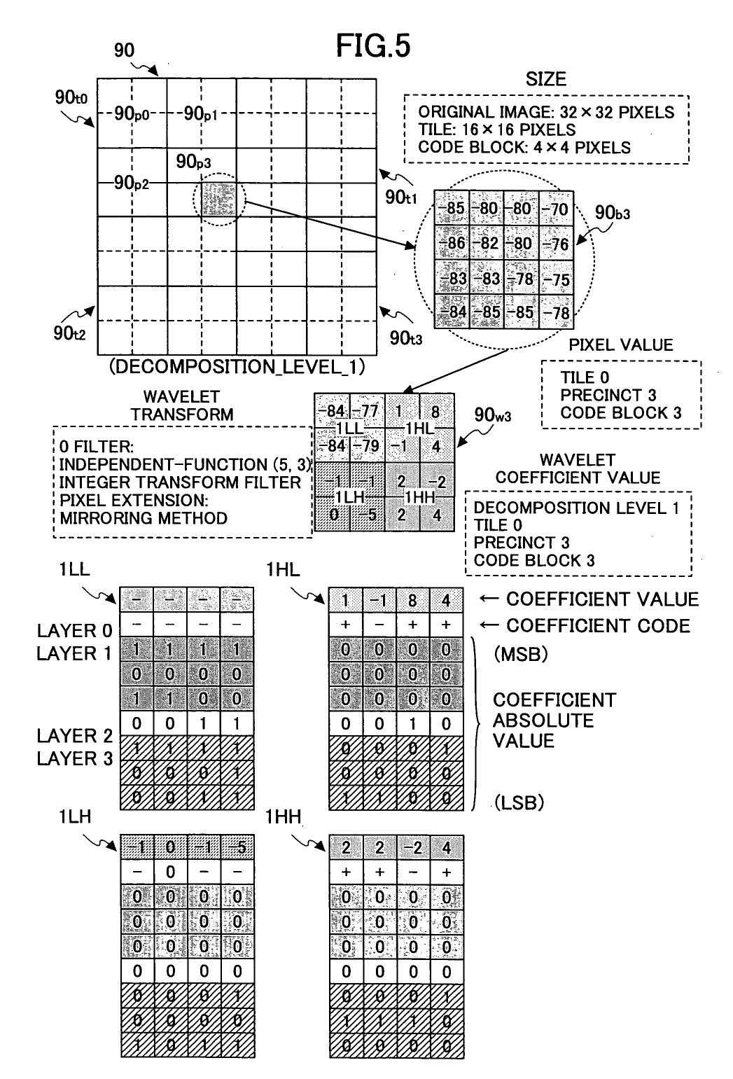

FIG. 5 is a diagram for illustrating the procedure for ordering the bit-planes. In the particular example shown in FIG. 5, an original image 90 (32×32 pixels) is divided into 4 tiles 90ₜ₀, 90ₜ₁, 90ₜ₂ and 90ₜ₃ each having 16×16 pixels. The sizes of the code block and the precinct at the decomposition level 1 respectively are 4×4 pixels and 8×8 pixels. The numbers of the precincts and the code blocks are assigned in a raster sequence. In this particular example, numbers 0 to 3 are assigned to the precincts, and numbers 0 to 3 are assigned to the code blocks. A mirroring method is used for the pixel expansion with respect to the outside of the tile boundary, and the wavelet transform is carried out by a independent-function (5, 3) integer transform filter to obtain the wavelet coefficients of the decomposition level 1.

In addition, FIG. 5 also generally shows the typical layer structure for the tile 90ₜ₀ (tile 0), precinct 90ₚ₃ (precinct 3) and the code block 90_{b3} (code block 3). A code block 90_{w3} after the transform is obtained by subjecting the code block 90_{b3} to the wavelet transform by the independent-function (5, 3) integer transform filter and obtaining the wavelet coefficient values of the decomposition level 1. The code block 90_{w3} after the transform is divided into the sub-bands (1LL, 1HL, 1LH, 1HH), and the wavelet coefficient values are allocated to each of the sub-bands.

The layer structure is easier to understand when the wavelet coefficient values are viewed from a horizontal direction (bit-plane direction). One layer is made up of an arbitrary number of bit-planes. In this example, each of the layers 0, 1, 2 and 3 is made up of bit-planes 1, 3, 1 and 3. The layer that includes a bit-plane closer to the LSB becomes the quantizing target earlier, and the layer including the bit-plane closer to the MSB becomes the quantizing target later and remains unquantized to the last. The method of discarding (or truncating) the layer closer to the LSB is called truncation, and the quantization rate can finely be controlled by this truncation.

In the entropy coding unit 103 shown in FIG. 1, the coding with respect to the tiles of each of the components is carried out by probability estimation from the context and target bits. Hence, the coding process is carried out in units of tiles for all of the components of the original image.

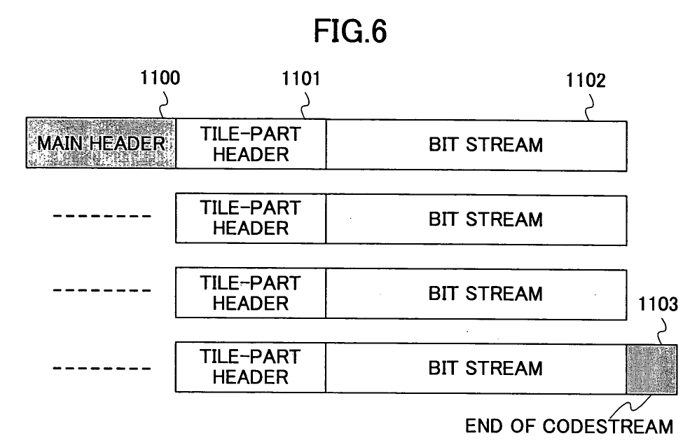

Finally, the tag processing unit 104 carries out a process of connecting all code data from the entropy coding unit 103 into one code stream and adding a tag to this code stream. FIG. 6 is a simplified diagram showing an example of the code stream structure. As shown in FIG. 6, tag information called a header is added to the head of the code stream and to the head of the partial tile forming each tile. A main header 1100 is added to the head of the code stream, and a tile-part header 1101 is added to the head of the partial file. The coded data (bit stream 1102) of each tile follows the tile-part header 1101. An end tag 1103 is also added to the end of the code stream.

On the other hand, at the time of the decoding, contrary to that at the time of the coding, the image data is generated from the code stream of each tile of each component, as will now be described briefly in conjunction with FIG. 1. In this case, the tag processing unit 104 interprets the tag information added to the code stream which is input from the outside, decomposes the code stream into the code stream of each tile 111 of each component 110, and carries out the decoding process (expansion process) for every code stream of each tile 111 of each component 110. The position of the bit that is the target of the decoding is determined by the order based on the tag information within the code stream, and the quantization and inverse quantization unit 102 generates the context from the arrangement of the peripheral bits (which have already been decoded) of the target bit position. The entropy coding and decoding unit 103 performs decoding according to the probability estimation from the context and the code stream to generate the target bit, and the target bit is written at the target bit position. The data decoded in this manner has been spatially divided for every frequency band. Hence, the decoded data is subjected to a two-dimensional wavelet inverse transform in the two-dimensional wavelet transform and inverse transform unit 101, in order to restore each tile 111 of each component 110 of the image data. The restored data is transformed into the original colorimetric system data by the color space transform and inverse transform unit 100. As a result, an expanding unit (or expanding function or procedure) is realized.

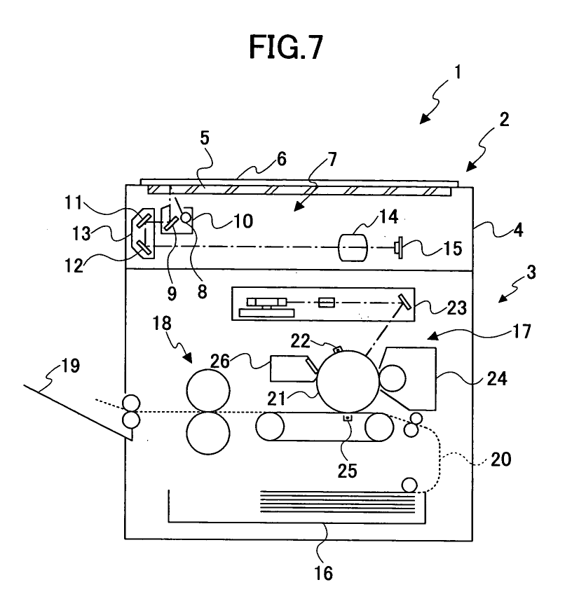

Next, a description will be given of a structure of one embodiment of the image processing apparatus, by referring to FIG. 7. FIG. 7 is a cross sectional view showing a general structure of one embodiment of the image processing apparatus. A composite apparatus 1 has composite functions, that is, a copying function, a printer function, a scanner function, a facsimile function, an image server function and the like.

As shown in FIG. 7, the composite apparatus 1 includes a scanner 2 and a printer 3. The scanner 2 forms an image reading unit for reading a document image of a document. The printer 3 forms an image forming unit for forming the document image read by the scanner 2 on a recording medium such as recording paper or sheet.

A contact glass 5 on which the document (not shown) is placed is provided at an upper surface portion of a main casing 4 of the scanner 2. When the document is placed on the contact glass 5, the document surface confronts the contact glass 5. A document holding member 6 is arranged on the contact glass 5 in order to hold the document in place on the contact glass 5. Of course, an Automatic Document Feeder (ADF) may be provided as the document holding member 6.

A reading optical system 7 for optically reading the document image is arranged under the contact glass 5. The reading optical system 7 is formed by a first moving body 10, a second moving body 13, and a Charge Coupled Device (CCD) image sensor 15. A light source 8 for emitting light and a mirror 9 are mounted on the first moving body 10. Two mirrors 11 and 12 are mounted on the second moving body 13. The CCD image sensor 15 receives the light that is reflected by the document surface, via the mirrors 9, 11 and 12 and an imaging lens 14. The CCD image sensor 15 functions as a photoelectric conversion element that generates photoelectric conversion data by subjecting the reflected light from the document, imaged on the CCD image sensor 15, to a photoelectric conversion. The photoelectric conversion data have voltages with magnitudes dependent on the intensity of the reflected light from the document. The first and second moving bodies 10 and 13 are movable to undergo a reciprocating movement along the contact glass 5. When carrying out a read operation to read the document image as will be described later, the first and second moving bodies 10 and 13 scan in a sub scan direction at a velocity ratio of 2:1 in response to a moving device such as a motor (not shown). As a result, an exposure scan of a document reading region is carried out by the reading optical system 7. In this embodiment, the reading optical system 7 moves to perform the scan and the document is fixed (stationary), but it is of course possible to move the document to perform the scan and maintain the reading optical system 7 in a fixed position.

The printer 3 includes a recording medium passage 20 through which the recording medium is transported from a recording medium holder 16 to an eject unit 19 via an electrophotography type printer engine 17 and a fixing unit 18.

The printer engine 17 uses a photoconductive body 21, a charger 22, an exposure unit 23, a developer 24, a transfer unit 25 and a cleaner 26, to transfer a toner image that is formed on a periphery of the photoconductive body 21 by electrophotography, onto the recording medium, and fixes the toner image on the recording medium by the fixing unit 18. In this embodiment, the printer engine 17 forms the image on the recording medium by electrophotography, but the image forming technique is not limited to electrophotography, and other suitable techniques may be employed for the image formation, such as ink-jet recording, sublimation type thermal transfer recording, direct thermal recording and the like.

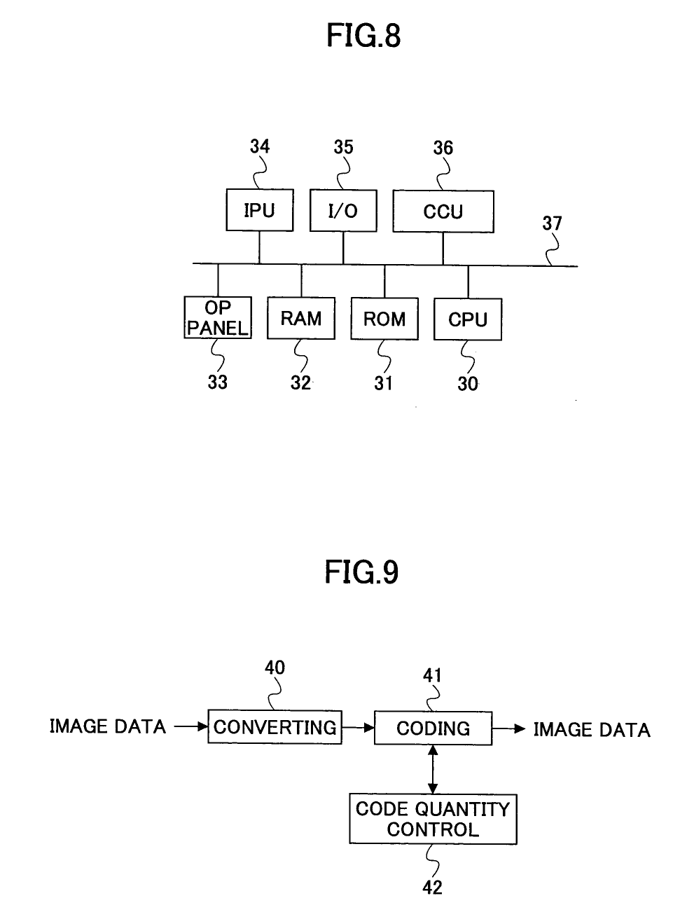

The composite apparatus 1 is controlled by a control system that is formed by one or a plurality of microcomputers. FIG. 8 is a system block diagram showing a structure of the control system of the image processing apparatus shown in FIG. 7, related to an image processing operation. The control system shown in FIG. 8 includes a CPU 30, a ROM 31, a RAM 32, an operation panel 33, an Image Processing Unit 34 (IPU) 34, an input and output (I/O) port 35, and a communication control unit (CCU) 36 which are connected via a bus 37.

The CPU 30 carries out various operations and centrally controls processes and operations of the composite apparatus 1 such as the image processing operation. The ROM 31 stores various programs and fixed data related to the processes that are carried out by the CPU 30. The ROM 31 includes a non-volatile memory such as an EEPROM and a flash memory, and also functions as a memory for storing the image data such as the image files. The programs stored in the ROM 31 are rewritable to programs that are downloaded from an external apparatus (not shown) via the I/O port 35 under the control of the CPU 30. The RAM 32 functions as a work area for the CPU 30, and also functions as a memory for temporarily storing the image data such as image files.

The operation panel 33 includes a display unit (not shown) formed by a Liquid Crystal Display (LCD) or the like, and a plurality of keys (not shown) formed by hard keys, a touch panel or the like. Hence, the operation panel 33 functions as a display unit and an operation unit. The IPU 34 includes hardware associated with various image processing operations. The CCU 36 has a function of transmitting and receiving data between the composite apparatus 1 and the external apparatus (not shown) via a network (not shown) or the like. Hence, the CCU 36 includes a modem function of a facsimile machine, a network control function for connecting to a public telephone line network, a function for controlling a Local Area Network (LAN) and the like.

In this embodiment, the ROM 31 forms one embodiment of the computer-readable storage medium that stores a program for causing the computer, that is, the CPU 30, to perform the image processing operation of this embodiment of the image processing apparatus.

Next, a description will be given of the image processing operation of the composite apparatus 1 of this embodiment, by referring to FIG. 9. FIG. 9 is a functional block diagram for illustrating an image processing system of the image processing apparatus shown in FIG. 7, that is, the composite apparatus 1. The image processing operation of the composite apparatus 1 includes processes carried out by a converting unit 40, a coding unit 41 and a code quantity control unit 42 shown in FIG. 9. The converting unit 40 carries out a hierarchical two-dimensional wavelet transform with respect to the original image (image data) that is read by the scanner 2. The coding unit 41 codes each of the plurality of sub-bands (sub-band images shown in FIG. 3, for example) that are hierarchically generated from the original image, based on a predetermined code quantity control parameter. The code quantity control unit 42 changes the code quantity control parameter based on the code quantity of a predetermined sub-band, in order to control the code quantities of the other sub-bands.

The code quantity control unit 42 may control the code quantity of the sub-band in a lower layer (lower hierarchical level) of the hierarchical structure based on the code quantity of the sub-band in an upper layer (upper hierarchical level) of the hierarchical structure. Alternatively, the code quantity control unit 42 may control the code quantity of the sub-band in a predetermined layer (predetermined hierarchical level) of the hierarchical structure based on the code quantity of the predetermined sub-band that is also in the predetermined layer (same predetermined hierarchical level) of the hierarchical structure. Hence, it is possible to accurately control the code quantity, and moreover, it is possible to perform the code quantity control that places priority on the image quality by controlling the code quantity from the upper layer (upper hierarchical level) of the hierarchical structure.

In this embodiment, the functions of the converting unit 40, the coding unit 41 and the code quantity control unit 42 may be realized by the image processing operation that is carried out by the CPU 30 based on one or a plurality of programs stored in the ROM 31. However, it is of course possible to realize the functions of the converting unit 40, the coding unit 41 and the code quantity control unit 42 by other means, such as by the image processing operation that is realized by the hardware of the IPU 34, for example. The converting unit 40 corresponds to the wavelet transform and inverse transform unit 101 shown in FIG. 1, and the coding unit 41 and the code quantity control unit 42 correspond to the quantization and inverse quantization unit 102 shown in FIG. 1.

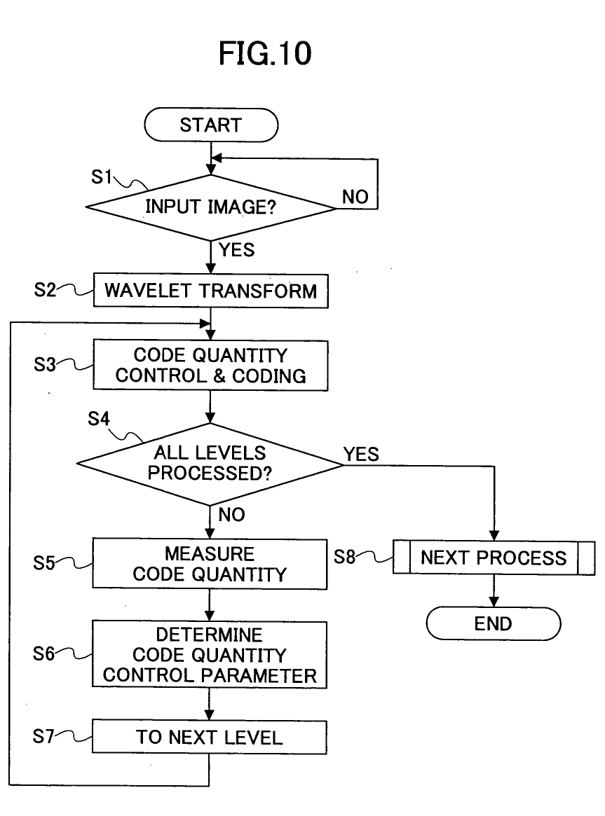

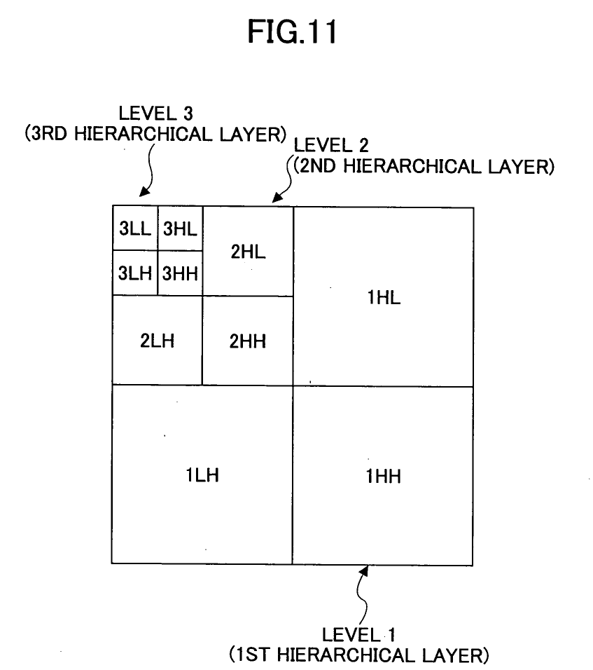

Next, a description will be given of the image processing operation of the composite apparatus 1 which is carried out by the CPU 30 based on the one or plurality of programs stored in the ROM 31. More particularly, a description will be given of the image processing operation that stores the image data in order to use the composite apparatus 1 as an image server, by referring to FIGS. 10 and 11. FIG. 10 is a flow chart for illustrating the image processing operation of one embodiment, and FIG. 11 is a diagram showing sub-bands for a case where the decomposition level is 3. The image processing operation described hereunder is for the case where the decomposition level is 3.

In FIG. 10, a step SI decides whether or not the document image is read by the scanner 2. When reading the document, an operator (or user) opens the document holding member 6 of the scanner 2 and sets the document on the contact glass 5. Then, the operator closes the document holding member 6 and pushes a start key of the operation panel 33. In response to the pushing of the start key, the scanner 2 reads the document image (original image) of the document that is set on the contact glass 5, by the scanning operation of the reading optical system 7.

When the original image of the document is read by the scanner 2 and the decision result in the step S1 becomes YES, a step S2 divides the original image into one or a plurality of rectangular regions (tiles 111), and carries out a two-dimensional wavelet transform with respect to a tile image (image data) of each rectangular region. Hence, a converting unit (or converting function or procedure) is realized by the step S2. As a result, the tile image of the rectangular region is divided into a plurality of sub-bands 3LL, 3HL, 3LH, 3HH, 2HL, 2KH, 2HH, 1HL, 1LH and 1HH shown in FIG. 11 by the two-dimensional wavelet transform. In other words, a plurality of sub-bands (sub-band images) are generated.

Next, the tile images are subjected to a hierarchical coding. More particularly, each of the sub-bands is coded while controlling the code quantity in an order depending on the hierarchical layer (hierarchical level). In this case, the code quantity is controlled for the level 3, the level 2 and the level 1 in this order. In other words, a step S3 codes the sub-bands 3LL, 3HL, 3LH and 3HH of the level 3 based on the predetermined code quantity control parameter. Hence, a coding unit (or coding function or procedure) is realized by the step S3. In addition, a portion of a code quantity control unit (or code quantity control function or procedure) is realized by the step S3. The predetermined code quantity control parameter is set in advance in this embodiment, but the predetermined code quantity control parameter is not limited to such. The control itself of the code quantity may be performed by a known method, such as a quantizing method that changes a quantization step width and a bit deleting method that deletes bits, and a description thereof will be omitted. For example, in the case of the quantizing method, the quantization step width increases as the code quantity control parameter increases to decrease the code quantity, while the quantization step width decreases as the code quantity control parameter decreases to increase the code quantity.

Next, a step S4 decides whether or not the coding is carried out with respect to the sub-bands 3LL, 3HL, 3LH, 3HH, 2HL, 2LH, 2HH, 1HL, 1LH and 1HH of all of the levels 3, 2 and 1 (hierarchical levels).

If the decision result in the step S4 is NO, a step S5 measures the code quantity of the sub-bands 3LL, 3HL, 3LH and 3HH of the level 3 which are coded, and a step S6 determines the code quantity control parameter based on the measured code quantity. Hence, a portion of the code quantity control unit (or code quantity control function or procedure) is realized by the steps S5 and S6. For example, a predicted value (predicted code quantity) of a next level that is lower may be calculated based on the measured code quantity by rule of thumb or from geometrical magnification of an upper level, and the code quantity control parameter may be determined based on the calculated predicted value. The code quantity control parameter that is determined in such a manner is used for the code quantity control for the next level that is lower. Any suitable known conventional methods may be used to calculate the predicted value, and a description thereof will be omitted.

Next, a step S7 changes a target level for which the code quantity control is to be carried out to the level 2 of the sub-bands 2HL, 2LH and 2HH, which is the next level that is lower than the level 3 of the sub-bands 3LL, 3HL, 3LH and 3HH which is coded, and the process returns to the step S3. Hence, the step S3 next codes the sub-bands 2HL, 2LH and 2HH of the level 2 based on the code quantity control parameter that is determined by the step S6. Hence, the coding unit (or coding function or procedure) and a portion of the code quantity control unit (or code quantity control function or procedure) are realized by the step S3.

When the steps S4 through S7 are thereafter carried out similarly as described above, the process returns to the step S3 which next codes the sub-bands 1HL, 1LH and 1HH of the level 1 based on the code quantity control parameter which is determined by the step S6 based on the code quantity of the level 2. Then, if the decision result in the step S4 becomes YES, a step S8 carries out a next process, and the process ends. For example, the next process may be a process that is based on the JPEG2000 algorithm and forms the code stream that is stored in the ROM (EEPROM, flash memory or the like) 31 as the image data (compressed data). If a plurality of documents exist, the image processing operation described above is performed with respect to each of the documents, and the plurality of image data are stored in the ROM 31 for each of the documents.

The image data stored in the ROM 31 are transmitted to the external apparatus via the CCU 36 and the network at a predetermined timing, for example, or decoded and recorded on the recording medium by the printer engine 17. The image described by the image data may be subjected to a process such as magnification (enlargement or reduction), rotation, black-and-white reversal and the like.

Therefore, this embodiment carries out the two-dimensional wavelet transform with respect to the original image (image data) in the step S2, changes the code quantity control parameter based on the code quantity of the sub-band of the upper level (for example, the level 3) in the step S6, and controls the code quantity of the lower level (for example, the level 2) based on the changed code quantity control parameter in the step S3. Thus, it is possible to control the code quantity of the sub-band with a high precision. Furthermore, since it is unnecessary to perform a decimation process or the like, it is possible to realize an accurate code quantity control and to reduce the processing time. In addition, since the code quantity of the sub-band in the lower level (lower hierarchical layer) is controlled by changing the code quantity control parameter based on the code quantity of the sub-band of the higher level (higher hierarchical layer), it is possible to realize the code quantity control that places priority on the image quality.

By employing the coding and the decoding based on the JPEG2000 algorithm, it is possible to perform various image processing operations that effectively utilize the characteristics of the JPEG2000. In addition, because the image is stored as images having various resolutions by the coding based on the JPEG2000 algorithm, the image quality of the image can freely be changed from the high image quality to the low image quality. Moreover, when displaying the original image on the display unit or the like, it is possible to expand the image to suit the resolution or the like of the display unit.

In this embodiment, the code quantity of the sub-band in the lower level (lower hierarchical layer) is controlled based on the code quantity of the sub-band of the higher level (higher hierarchical layer), but the code quantity control is not limited to such. For example, based on the code quantity of the sub-band in a predetermined level (predetermined hierarchical layer), it is of course possible to control the code quantity of another sub-band that is in the same predetermined level (same predetermined hierarchical layer).

In addition, in this embodiment and each of the embodiments described hereunder, the image data (compressed data) described as being stored in the ROM 31 may of course be stored in the RAM 32.

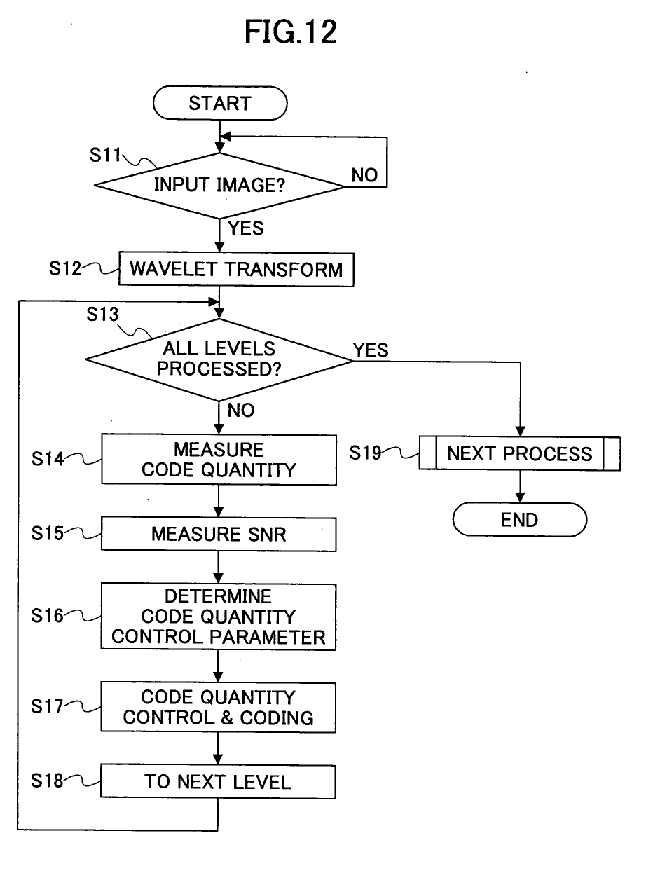

Next, a description will be given of another embodiment of the image processing apparatus according to the present invention, by referring to FIGS. 11 and 12. FIG. 12 is a flow chart for illustrating an image processing operation of this embodiment of the image processing apparatus. This embodiment of the image processing apparatus employs another embodiment of the computer-readable storage medium according to the present invention. In this embodiment, the present invention is also applied to the composite apparatus 1 shown in FIGS. 7 and 8. Furthermore, this embodiment utilizes the JPEG2000 algorithm.

The basic structure of this embodiment of the image processing apparatus is the same as that of the embodiment described above, except that the image processing operation which is carried out by the CPU 30 of the composite apparatus 1 based on one or a plurality of programs is different from that of the embodiment described above.

A description will be given of the image processing operation that is performed by the CPU 30 of the composite apparatus 1 based on one or a plurality of programs, to store the image data as an image server. The image processing operation described hereunder is for the case where the decomposition level is 3.

In FIG. 12, a step S1 1 decides whether or not the document image is read by the scanner 2. When reading the document, an operator (or user) opens the document holding member 6 of the scanner 2 and sets the document on the contact glass 5. Then, the operator closes the document holding member 6 and pushes a start key of the operation panel 33. In response to the pushing of the start key, the scanner 2 reads the document image (original image) of the document that is set on the contact glass 5, by the scanning operation of the reading optical system 7.

When the original image of the document is read by the scanner 2 and the decision result in the step S11 becomes YES, a step S12 divides the original image into one or a plurality of rectangular regions (tiles 111), and carries out a two-dimensional wavelet transform with respect to a tile image (image data) of each rectangular region. Hence, the converting unit (or converting function or procedure) is realized by the step S12. As a result, the tile image of the rectangular region is divided into a plurality of sub-bands 3LL, 3HL, 3LH, 3HH, 2HL, 2KH, 2HH, 1HL, 1LH and 1HH shown in FIG. 11 by the two-dimensional wavelet transform. In other words, a plurality of sub-bands (sub-band images) are generated.

Next, the tile images are subjected to a hierarchical coding. More particularly, each of the sub-bands is coded while controlling the code quantity in an order depending on the hierarchical layer (hierarchical level). In this case, the code quantity is controlled for the level 3, the level 2 and the level 1 in this order. But first, a step S13 decides whether or not the coding is carried out with respect to the sub-bands 3LL, 3HL, 3LH, 3HH, 2HL, 2LH, 2HH, 1HL, 1LH and 1HH of all of the levels 3, 2 and 1 (hierarchical levels).

If the decision result in the step S13 is NO, a step S 14 codes a reduced image (3LL) of the level 3 having a predetermined number of input pixels and measures the output code quantity, and a step S14 measures a signal-to-noise ratio (SNR) of the reduced image. A step S16 determines the code quantity control parameter based on the output code quantity of the reduced image and the SNR that are obtained. A portion of the code quantity control unit (or code quantity control function or procedure) is realized by the step S16.

The step S16 determines the code quantity control parameter by comparing the output code quantity and the SNR of the reduced image that are obtained with predicted information which is prestored in the ROM 31. For example, the predicted information which is prestored in the ROM 31 may be a graph, table or the like indicating the relationship of the number of input pixels and the output code quantity using the SNR as a parameter or, a formula indicating a curve of the graph, with respect to a typical image (test chart of ITS (Television Society)). By using the graph, formula or the like, the typical image having characteristics similar to those of the image of the level 3 can be obtained based on the output code quantity and the SNR of the reduced image of the level 3. The output code quantity for an arbitrary number of input pixels may be obtained from the graph, formula or the like of the typical image, and the obtained output code quantity may be set as the predicted value (predicted code quantity). Hence, the code quantity control parameter may be determined based on the predicted value. Any suitable known conventional methods may be used to make the comparison with the predicted value, and a description thereof will be omitted.

A step S17 codes the sub-bands 3LL, 3HL, 3LH and 3HH of the level 3 based on the code quantity control parameter that is determined by the step S16. Hence, the coding unit (or coding function or procedure) is realized by the step S17. In addition, a portion of the code quantity control unit (or code quantity control function or procedure) is realized by the step S 17. The sub-bands of the level 3 are coded based on the predetermined code quantity (predicted code quantity). By changing the code quantity control parameter based on the code quantity of the predetermined sub-band 3LL, this embodiment controls the code quantity of the other sub-bands 3HL, 3LH and 3HH of the same level (same hierarchical layer) as the sub-band 3LL. However, the control of the code quantity is not limited to such, and for example, it is possible to control the code quantity of the sub-bands 2HL, 2LH and 2HH of the lower level (lower hierarchical layer).

Next, a step S118 changes a target level for which the code quantity control is to be carried out to the level 2 of the sub-bands 2HL, 2LH and 2HH, which is the next level that is lower than the level 3 of the sub-bands 3LL, 3HL, 3LH and 3HH which is coded, and the process returns to the step S13.

Hence, by repeating the steps S13 through S18 similarly as described above, the step S17 next codes the sub-bands 2HL, 2LH and 2HH of the level 2 based on the code quantity control parameter which is determined by the immediately preceding step S16, and after the process returns to the step S13 again, the step S17 then codes the sub-bands 1HL, 1LH and 1HH of the level 1 based on the code quantity control parameter which is determined by the immediately preceding step S16.

If the decision result in the step S13 becomes YES, a step S19 carries out a next process, and the process ends. For example, the next process may be a process that is based on the JPEG2000 algorithm and forms the code stream that is stored in the ROM (EEPROM, flash memory or the like) 31 as the image data (compressed data). If a plurality of documents exist, the image processing operation described above is performed with respect to each of the documents, and the plurality of image data are stored in the ROM 31 for each of the documents.

The image data stored in the ROM 31 are transmitted to the external apparatus via the CCU 36 and the network at a predetermined timing, for example, or decoded and recorded on the recording medium by the printer engine 17. The image described by the image data may be subjected to a process such as magnification (enlargement or reduction), rotation, black-and-white reversal and the like.

Therefore, this embodiment performs the two-dimensional wavelet transform with respect to the original image (image data) in the step S12, changes the code quantity control parameter based on the code quantity of the predetermined sub-band (for example, 3LL) in the step S16, and controls the code quantity of the other sub-bands (for example, 3HL, 3LH and 3HH) of the same level as the predetermined sub-band based on the changed code quantity control parameter in the step S17. Thus, it is possible to control the code quantity of the sub-band with a high precision. Furthermore, since it is unnecessary to perform a decimation process or the like, it is possible to realize an accurate code quantity control and to reduce the processing time.

By employing the coding and the decoding based on the JPEG2000 algorithm, it is possible to perform various image processing operations that effectively utilize the characteristics of the JPEG2000. In addition, because the image is stored as images having various resolutions by the coding based on the JPEG2000 algorithm, the image quality of the image can freely be changed from the high image quality to the low image quality. Moreover, when displaying the original image on the display unit or the like, it is possible to expand the image to suit the resolution or the like of the display unit.

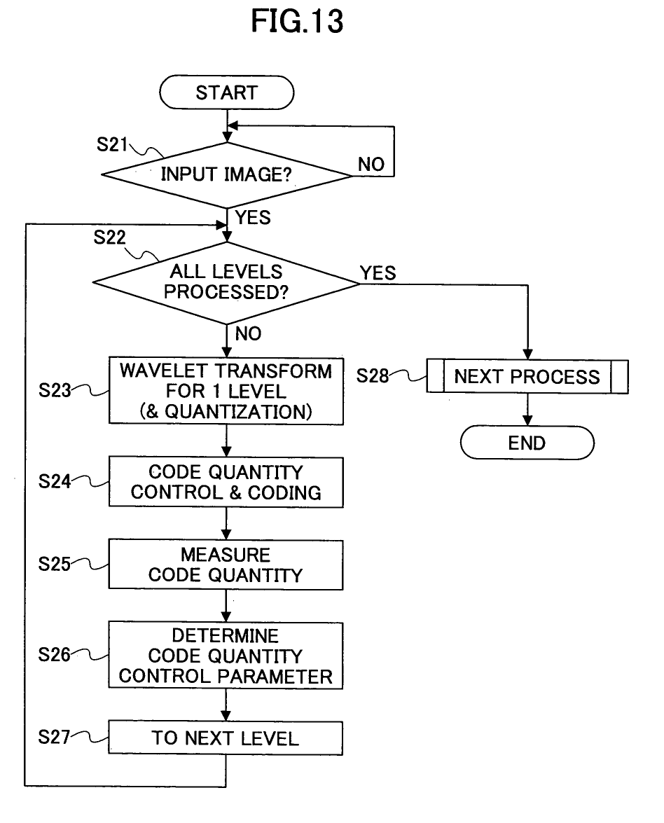

Next, a description will be given of another embodiment of the image processing apparatus according to one embodiment of the present invention, by referring to FIG. 13. FIG. 13 is a flow chart for illustrating an image processing operation of this embodiment of the image processing apparatus. This embodiment of the image processing apparatus employs another embodiment of the computer-readable storage medium according to the present invention. In this embodiment, the present invention is also applied to the composite apparatus 1 shown in FIGS. 7 and 8. Furthermore, this embodiment utilizes the JPEG2000 algorithm.

The basic structure of this embodiment of the image processing apparatus is the same as that of the embodiment described above, except that the image processing operation which is carried out by the CPU 30 of the composite apparatus 1 based on one or a plurality of programs is different from that of the embodiment described above.

A description will be given of the image processing operation which is carried out by the CPU 30 of the composite apparatus 1 based on one or a plurality of programs, to store the image data as an image server. The image processing operation described hereunder is for the case where the decomposition level is 3.

In FIG. 13, a step S21 decides whether or not the document image is read by the scanner 2. When reading the document, an operator (or user) opens the document holding member 6 of the scanner 2 and sets the document on the contact glass 5. Then, the operator closes the document holding member 6 and pushes a start key of the operation panel 33. In response to the pushing of the start key, the scanner 2 reads the document image (original image) of the document that is set on the contact glass 5, by the scanning operation of the reading optical system 7.

When the original image of the document is read by the scanner 2 and the decision result in the step S21 becomes YES, a step S22 decides whether or not the coding is carried out with respect to the sub-bands 3LL, 3HL, 3LH, 3HH, 2HL, 2LH, 2HH, 1HL, 1LH and 1HH of all of the levels 3, 2 and 1 (hierarchical levels). If the decision result in the step S22 is NO, a step S23 divides the original image into one or a plurality of rectangular regions (tiles 111), and performs a two-dimensional wavelet transform with respect to a tile image (image data) of each rectangular region. More particularly, the step S23 carries out the two-dimensional wavelet transform with respect to the sub-bands of one level (hierarchical layer). Hence, the converting unit (or converting function or procedure) is realized by the step S23. As a result, the tile image of the rectangular region is divided into a plurality of sub-bands 3LL, 3HL, 3LH, 3HH, 2HL, 2KH, 2HH, 1HL, 1LH and 1HH shown in FIG. 11 by the two-dimensional wavelet transform which is performed with respect to the sub-bands of all of the levels 3, 2 and 1. In other words, a plurality of sub-bands (sub-band images) are generated.

Next, the tile images are subjected to a hierarchical coding. More particularly, each of the sub-bands is coded while controlling the code quantity in an order depending on the hierarchical layer (hierarchical level). In this case, the code quantity is controlled for the level 3, the level 2 and the level 1 in this order. First, a step S24 codes the sub-bands 3LL, 3HL, 3LH and 3HH of the level 3 based on a predetermined code quantity control parameter. The coding unit (or coding function or procedure) and a portion of the code quantity control unit (or code quantity control function or procedure) are realized by the step S24. The predetermined code quantity control parameter is set in advance in this embodiment, but the predetermined code quantity control parameter is not limited to such. The control itself of the code quantity may be carried out by a known method, such as a quantizing method that changes a quantization step width and a bit deleting method that deletes bits, and a description thereof will be omitted. For example, in the case of the quantizing method, the quantization step width increases as the code quantity control parameter increases to decrease the code quantity, while the quantization step width decreases as the code quantity control parameter decreases to increase the code quantity.

Next, a step S25 measures the code quantity of the sub-bands 3LL, 3HL, 3LH and 3HH of the level 3 that is coded. A step S26 determines the code quantity control parameter based on the measured code quantity. Hence, a portion of the code quantity control unit (or code quantity control function or procedure) is realized by the steps S25 and S26. For example, a predicted value (predicted code quantity) of a next level which is lower may be calculated based on the measured code quantity by rule of thumb or from geometrical magnification of an upper level, and the code quantity control parameter may be determined based on the calculated predicted value. The code quantity control parameter that is determined in such a manner is used for the code quantity control for the next level that is lower. Any suitable known conventional methods may be used to calculate the predicted value, and a description thereof will be omitted.

A step S27 changes a target level for which the code quantity control is to be carried out to the level 2 of the sub-bands 2HL, 2LH and 2HH, which is the next level that is lower than the level 3 of the sub-bands 3LL, 3HL, 3LH and 3HH which is coded, and the process returns to the step S22. After the steps S22 and S23, the step S24 codes the sub-bands 2HL, 2LH and 2HH of the level 2 based on the code quantity control parameter that is determined by the step S26. Hence, the coding unit (or coding function or procedure) and a portion of the code quantity control unit (or code quantity control function or procedure) are realized by the step S24.

Hence, by repeating the steps S22 through S27 similarly as described above, the step S26 next determines the code quantity control parameter based on the code quantity of the level 2, the step S24 codes the sub-bands 1HL, 1LH and 1HH of the level 1 based on the code quantity control parameter which is determined by the immediately preceding step S26, and the process returns to the step S22 again. If the decision result in the step S22 becomes YES, a step S28 carries out a next process, and the process ends. For example, the next process may be a process that is based on the JPEG2000 algorithm and forms the code stream that is stored in the ROM (EEPROM, flash memory or the like) 31 as the image data (compressed data). If a plurality of documents exist, the image processing operation described above is carried out with respect to each of the documents, and the plurality of image data are stored in the ROM 31 for each of the documents.

The image data stored in the ROM 31 are transmitted to the external apparatus via the CCU 36 and the network at a predetermined timing, for example, or decoded and recorded on the recording medium by the printer engine 17. The image described by the image data may be subjected to a process such as magnification (enlargement or reduction), rotation, black-and-white reversal and the like.

Therefore, this embodiment performs the two-dimensional wavelet transform with respect to each level (hierarchical layer) of the original image (image data) in the step S23, changes the code quantity control parameter based on the code quantity of the sub-band of the higher level (for example, the level 3) in the step S26, and controls the code quantity of the lower level (for example, the level 2) based on the changed code quantity control parameter in the step S24. Thus, it is possible to control the code quantity of the sub-band with a high precision. Furthermore, since it is unnecessary to perform a decimation process or the like, it is possible to realize an accurate code quantity control and to reduce the processing time. In addition, since the code quantity of the sub-band in the lower level (lower hierarchical layer) is controlled by changing the code quantity control parameter based on the code quantity of the sub-band of the higher level (higher hierarchical layer), it is possible to realize the code quantity control which places priority on the image quality.

By carrying out the code quantity control at the two-dimensional wavelet transform stage, the bit depth of the wavelet coefficients to be stored is reduced, and it is possible to reduce the storage capacity required to storage the image data. For example, by discarding (or truncating) the lower 4 bits of an 8-bit wavelet coefficient, the wavelet coefficient becomes only 4 bits, thereby enabling the required storage capacity for the wavelet coefficient to be reduced to one-half. If it is a precondition that only an irreversible coding is to be carried out, such as a Large Scaled Integrated Circuit (LSI) that only performs irreversible coding, areas of a processing module and a memory module to be mounted can be reduced, to thereby enable production of LSIs having an improved yield.

Further, by employing the coding and the decoding based on the JPEG2000 algorithm, it is possible to perform various image processing operations that effectively utilize the characteristics of the JPEG2000. In addition, because the image is stored as images having various resolutions by the coding based on the JPEG2000 algorithm, the image quality of the image can freely be changed from the high image quality to the low image quality. Moreover, when displaying the original image on the display unit or the like, it is possible to expand the image to suit the resolution or the like of the display unit.

In this embodiment, the code quantity of the sub-band in the lower level (lower hierarchical layer) is controlled based on the code quantity of the sub-band of the higher level (higher hierarchical layer), but the code quantity control is not limited to such. For example, based on the code quantity of the sub-band in a predetermined level (predetermined hierarchical layer), it is of course possible to control the code quantity of another sub-band that is in the same predetermined level (same predetermined hierarchical layer).

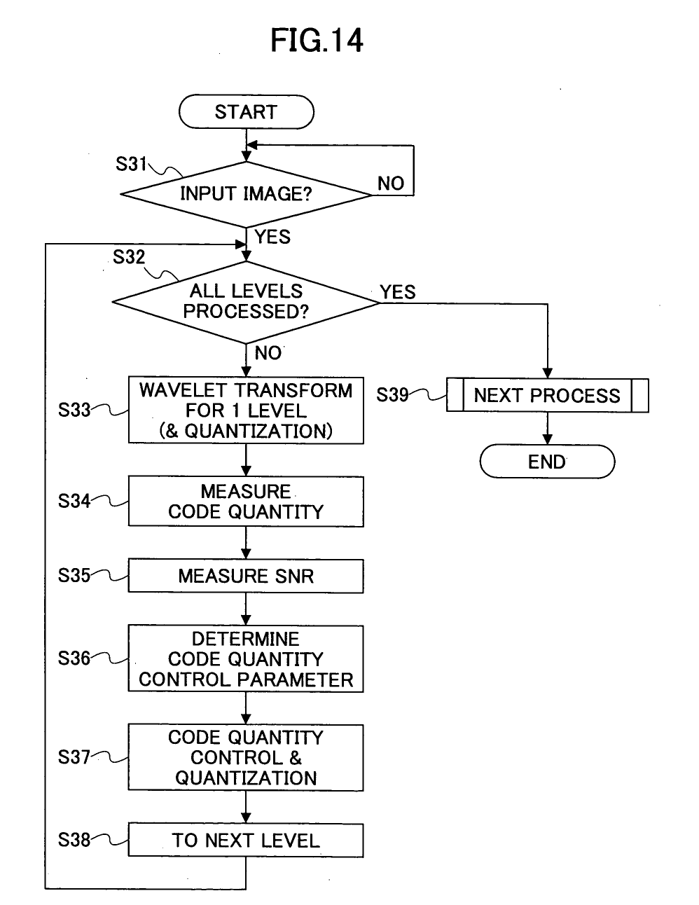

Next, a description will be given of another embodiment of the image processing apparatus according to the present invention, by referring to FIG. 14. FIG. 14 is a flow chart for illustrating an image processing operation of this embodiment of the image processing apparatus. This embodiment of the image processing apparatus employs another embodiment of the computer-readable storage medium according to the present invention. In this embodiment, the present invention is also applied to the composite apparatus 1 shown in FIGS. 7 and 8. Furthermore, this embodiment utilizes the JPEG2000 algorithm.

The basic structure of this embodiment of the image processing apparatus is the same as that of the embodiment described above, except that the image processing operation which is carried out by the CPU 30 of the composite apparatus 1 based on one or a plurality of programs is different from that of the embodiment described above.

A description will be given of the image processing operation which is performed by the CPU 30 of the composite apparatus 1 based on one or a plurality of programs, to store the image data as an image server. The image processing operation described hereunder is for the case where the decomposition level is 3.

In FIG. 14, a step S31 decides whether or not the document image is read by the scanner 2. When reading the document, an operator (or user) opens the document holding member 6 of the scanner 2 and sets the document on the contact glass 5. Then, the operator closes the document holding member 6 and pushes a start key of the operation panel 33. In response to the pushing of the start key, the scanner 2 reads the document image (original image) of the document that is set on the contact glass 5, by the scanning operation of the reading optical system 7.

When the original image of the document is read by the scanner 2 and the decision result in the step S31 becomes YES, a step S32 decides whether or not the coding is carried out with respect to the sub-bands 3LL, 3HL, 3LH, 3HH, 2HL, 2LH, 2HH, 1HL, 1LH and 1HH of all of the levels 3, 2 and 1 (hierarchical levels). If the decision result in the step S32 is NO, a step S33 divides the original image into one or a plurality of rectangular regions (tiles 111), and performs a two-dimensional wavelet transform with respect to a tile image (image data) of each rectangular region. More particularly, the step S33 performs the two-dimensional wavelet transform with respect to the sub-bands of one level (hierarchical layer). Hence, the converting unit (or converting function or procedure) is realized by the step S33. As a result, the tile image of the rectangular region is divided into a plurality of sub-bands 3LL, 3HL, 3LH, 3HH, 2HL, 2KH, 2HH, 1HL, 1LH and 1HH shown in FIG. 11 by the two-dimensional wavelet transform which is performed with respect to the sub-bands of all of the levels 3, 2 and 1. In other words, a plurality of sub-bands (sub-band images) are generated.

Next, a step S34 codes a reduced image (3LL) of the level 3 having a predetermined number of input pixels and measures the output code quantity, and a step S44 measures a signal-to-noise ratio (SNR) of the reduced image. A step S36 determines the code quantity control parameter based on the output code quantity of the reduced image and the SNR that are obtained. A portion of the code quantity control unit (or code quantity control function or procedure) is realized by the step S36.

The step S36 determines the code quantity control parameter by comparing the output code quantity and the SNR of the reduced image that are obtained with predicted information which is prestored in the ROM 31. For example, the predicted information which is prestored in the ROM 31 may be a graph, table or the like indicating the relationship of the number of input pixels and the output code quantity using the SNR as a parameter or, a formula indicating a curve of the graph, with respect to a typical image (test chart of ITS (Television Society)). By using the graph, formula or the like, the typical image having characteristics similar to those of the image of the level 3 can be obtained based on the output code quantity and the SNR of the reduced image of the level 3. The output code quantity for an arbitrary number of input pixels may be obtained from the graph, formula or the like of the typical image, and the obtained output code quantity may be set as the predicted value (predicted code quantity). Hence, the code quantity control parameter may be determined based on the predicted value. Any suitable known conventional methods may be used to make the comparison with the predicted value, and a description thereof will be omitted.

A step S37 codes the sub-bands 3LL, 3HL, 3LH and 3HH of the level 3 based on the code quantity control parameter that is determined by the step S36. Hence, the coding unit (or coding function or procedure) is realized by the step S37. In addition, a portion of the code quantity control unit (or code quantity control function or procedure) is realized by the step S37. The sub-bands of the level 3 are coded based on the predetermined code quantity (predicted code quantity). By changing the code quantity control parameter based on the code quantity of the predetermined sub-band 3LL, this embodiment controls the code quantity of the other sub-bands 3HL, 3LH and 3HH of the same level (same hierarchical layer) as the sub-band 3LL. However, the control of the code quantity is not limited to such, and for example, it is possible to control the code quantity of the sub-bands 2HL, 2LH and 2HH of the lower level (lower hierarchical layer).

Next, a step S38 changes a target level for which the code quantity control is to be carried out to the level 2 of the sub-bands 2HL, 2LH and 2HH, which is the next level that is lower than the level 3 of the sub-bands 3LL, 3HL, 3LH and 3HH which is coded, and the process returns to the step S13.

Hence, by repeating the steps S32 through S38 similarly as described above, the step S37 next codes the sub-bands 2HL, 2LH and 2HH of the level 2 based on the code quantity control parameter which is determined by the immediately preceding step S36, and after the process returns to the step S33 again, the step S37 then codes the sub-bands 1HL, 1 LH and 1HH of the level 1 based on the code quantity control parameter which is determined by the immediately preceding step S36.

If the decision result in the step S32 becomes YES, a step S39 carries out a next process, and the process ends. For example, the next process may be a process that is based on the JPEG2000 algorithm and forms the code stream that is stored in the ROM (EEPROM, flash memory or the like) 31 as the image data (compressed data). If a plurality of documents exist, the image processing operation described above is performed with respect to each of the documents, and the plurality of image data are stored in the ROM 31 for each of the documents.

The image data stored in the ROM 31 are transmitted to the external apparatus via the CCU 36 and the network at a predetermined timing, for example, or decoded and recorded on the recording medium by the printer engine 17. The image described by the image data may be subjected to a process such as magnification (enlargement or reduction), rotation, black-and-white reversal and the like.

Therefore, this embodiment performs the two-dimensional wavelet transform with respect to each level (hierarchical layer) of the original image (image data) in the step S33, changes the code quantity control parameter based on the code quantity of the predetermined sub-band (for example, 3LL) in the step S36, and controls the code quantity of the other sub-bands (for example, 3HL, 3LH and 3HH) of the same level as the predetermined sub-band based on the changed code quantity control parameter in the step S37. Thus, it is possible to control the code quantity of the sub-band with a high precision. Furthermore, since it is unnecessary to perform a decimation process or the like, it is possible to realize an accurate code quantity control and to reduce the processing time.

By carrying out the code quantity control at the two-dimensional wavelet transform stage, the bit depth of the wavelet coefficients to be stored is reduced, and it is possible to reduce the storage capacity required to storage the image data. For example, by discarding (or truncating) the lower 4 bits of an 8-bit wavelet coefficient, the wavelet coefficient becomes only 4 bits, thereby enabling the required storage capacity for the wavelet coefficient to be reduced to one-half. If it is a precondition that only an irreversible coding is to be carried out, such as a Large Scaled Integrated Circuit (LSI) which only carries out irreversible coding, areas of a processing module and a memory module to be mounted can be reduced, to thereby enable production of LSIs having an improved yield.

By employing the coding and the decoding based on the JPEG2000 algorithm, it is possible to perform various image processing operations that effectively utilize the characteristics of the JPEG2000. In addition, because the image is stored as images having various resolutions by the coding based on the JPEG2000 algorithm, the image quality of the image can freely be changed from the high image quality to the low image quality. Moreover, when displaying the original image on the display unit or the like, it is possible to expand the image to suit the resolution or the like of the display unit.

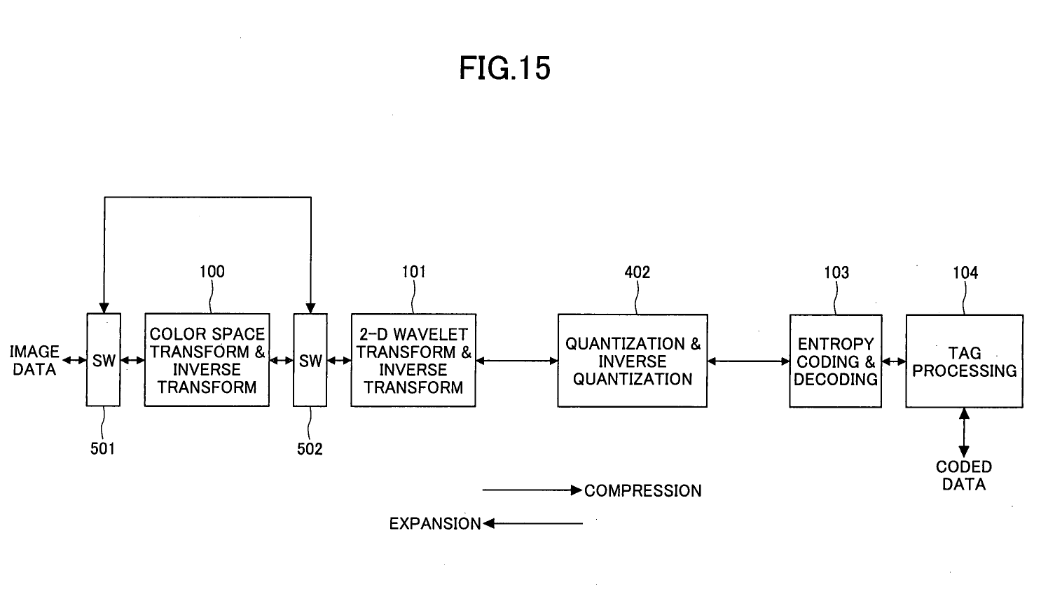

A description will be given of another embodiment of the present invention, by referring to FIG. 15. FIG. 15 is a functional block diagram for illustrating an image processing system of one embodiment of the image processing apparatus according to the present invention. In FIG. 15, those units that are the same as those corresponding units in FIG. 1 are designated by the same reference numerals, and a description thereof will be omitted.

The basic structure of the image processing apparatus of this embodiment is the same as that of the embodiment described above, except that the image processing operation which is carried out by the CPU 30 of the composite apparatus 1 based on one or a plurality of programs is different from that of the embodiment described above.

A description will be given of the image processing operation which is carried out by the CPU 30 of the composite apparatus 1 based on one or a plurality of programs, to store the image data as an image server. In FIG. 15, a switch (SW) 501 supplies the image data to the color space transform and inverse transform unit 100 at the time of the image data compression during a normal mode. But in a mode which bypasses the color space transform and inverse transform unit 100, the switch 501 is switched in response to a switching signal to supply the image data to the two-dimensional wavelet transform and inverse transform unit 101 via a switch 502. A quantization and inverse quantization unit 402 includes the coding unit 41 and the code quantity control unit 42 shown in FIG. 9.

In addition, the switch 502 supplies the image data from the two-dimensional wavelet transform and inverse transform unit 101 to the color space transform and inverse transform unit 100 at the time of the image data expansion in the normal mode. However, in the mode which bypasses the color space transform and inverse transform unit 100, the switch 502 is switched in response to a switching signal to output the image data from the two-dimensional wavelet transform and inverse transform unit 101 via the switch 501. The switching of the switches 501 and 502 may be linked.

According to this embodiment, it is possible to selectively process the image data by the color space transform and inverse transform unit 100 depending on the image data or a user request.

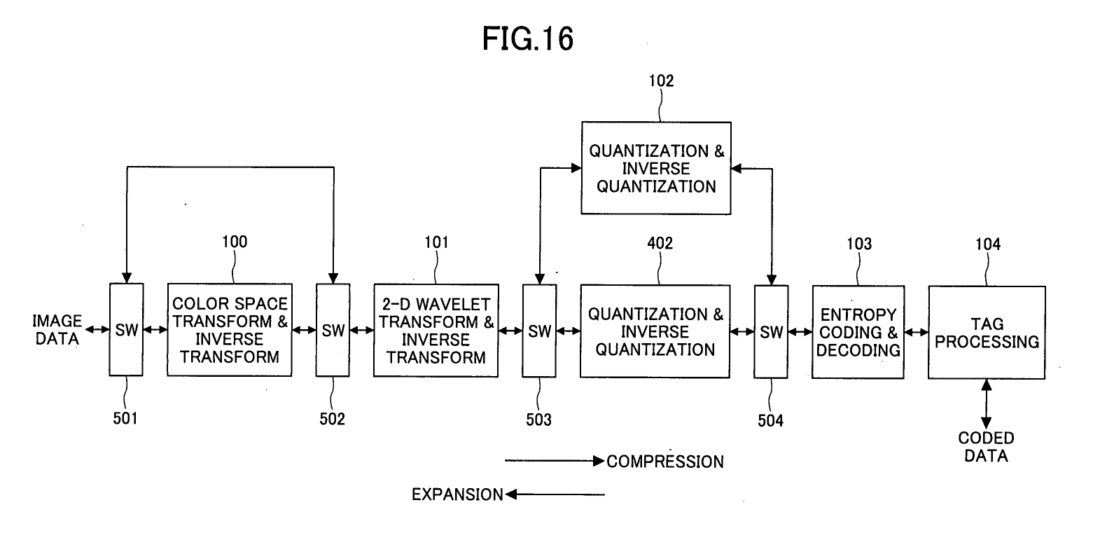

A description will be given of another embodiment of the present invention, by referring to FIG. 16. FIG. 16 is a functional block diagram for illustrating an image processing system of this embodiment of the image processing apparatus according to the present invention. In FIG. 16, those units that are the same as those corresponding units in FIGS. 1 and 15 are designated by the same reference numerals, and a description thereof will be omitted.

The basic structure of the image processing apparatus of this embodiment is the same as that of the embodiment described above, except that the image processing operation which is performed by the CPU 30 of the composite apparatus 1 based on one or a plurality of programs is different from that of the embodiment described above.

A description will be given of the image processing operation which is carried out by the CPU 30 of the composite apparatus 1 based on one or a plurality of programs, to store the image data as an image server.

In FIG. 16, a switch (SW) 503 supplies the data from the two-dimensional wavelet transform and inverse transform unit 101 to the quantization and inverse quantization unit 402 at the time of the image data compression in a mode which places priority on the image quality. But in a mode that bypasses the quantization and inverse quantization unit 402, the switch 503 is switched in response to a switching signal to supply the data from the two-dimensional wavelet transform and inverse transform unit 101 to the entropy coding and decoding unit 103 via the quantization and inverse quantization unit 102 and a switch 504.

On the other hand, the switch 504 supplies the image data from the entropy coding and decoding unit 103 to the quantization and inverse quantization unit 402 at the time of the image data expansion in the mode which places priority on the image quality. However, in the mode that bypasses the quantization and inverse quantization unit 402, the switch 504 is switched in response to a switching signal to supply the image data from the entropy coding and decoding unit 103 to the two-dimensional wavelet transform and inverse transform unit 101 via the quantization and inverse quantization unit 102 and the switch 503. The quantization and inverse quantization unit 102 performs the conventional quantization and inverse quantization process that does not control the code quantity, that is, using a predetermined code quantity. The switching of the switches 503 and 504 may be linked.

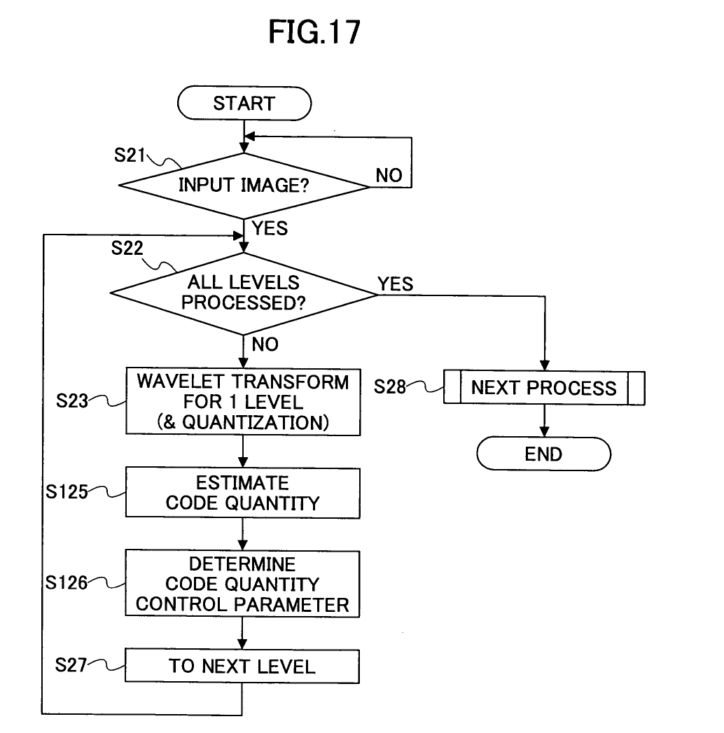

Next, a description will be given of another embodiment of the image processing apparatus according to the present invention, by referring to FIG. 17. FIG. 17 is a flow chart for illustrating an image processing operation of this embodiment of the image processing apparatus. This embodiment of the image processing apparatus employs another embodiment of the computer-readable storage medium according to one embodiment of the present invention. In this embodiment, the present invention is also applied to the composite apparatus 1 shown in FIGS. 7 and 8. Furthermore, this embodiment utilizes the JPEG2000 algorithm.

The basic structure of this embodiment of the image processing apparatus is the same as that of the embodiment described above, except that the image processing operation that is performed by the CPU 30 of the composite apparatus 1 based on one or a plurality of programs is different from that of the embodiment described above.

A description will be given of the image processing operation which is carried out by the CPU 30 of the composite apparatus 1 based on one or a plurality of programs, to store the image data as an image server.

In FIG. 17, those steps that are the same as those corresponding steps in FIG. 13 are designated by the same reference numerals, and a description thereof will be omitted. In this embodiment, the step S24 shown in FIG. 13 is not provided, and steps S125 and S126 are provided in place of the steps S25 and S26, as shown in FIG. 17. When not carrying out the coding, it is not possible to obtain an accurate code quantity. For this reason, the step S125 makes an estimate for a case where each bit plane is discarded (or truncated), in order to obtain an estimated quantity of the code quantity. More particularly, the code quantity is estimated using values in a table that stores information indicating the code quantity with respect to each number of bits reduced, based on past statistical data, for example. Since the code quantity is controlled using the estimated quantity, the step S126 determines the code quantity control parameter based on the estimated quantity, and truncates the present sub-band by obtaining the bit-plane to be truncated.

For example, a table of truncating bit-plane versus code quantity obtained from the rule of thumb may be prepared in advance, and a bit-plane value may be substituted into this table, in order to obtain the estimated quantity of the code quantity. The estimated quantity may be obtained using only a fixed table or, corrected using actually measured values obtained when coding the immediately preceding tile. In the latter case, the correcting method is not limited to a particular method. For example, the correcting method may be a method that uses the values of the immediately preceding tile as they are or, a method that uses an average of the values of the immediately preceding tile and the values of the table.

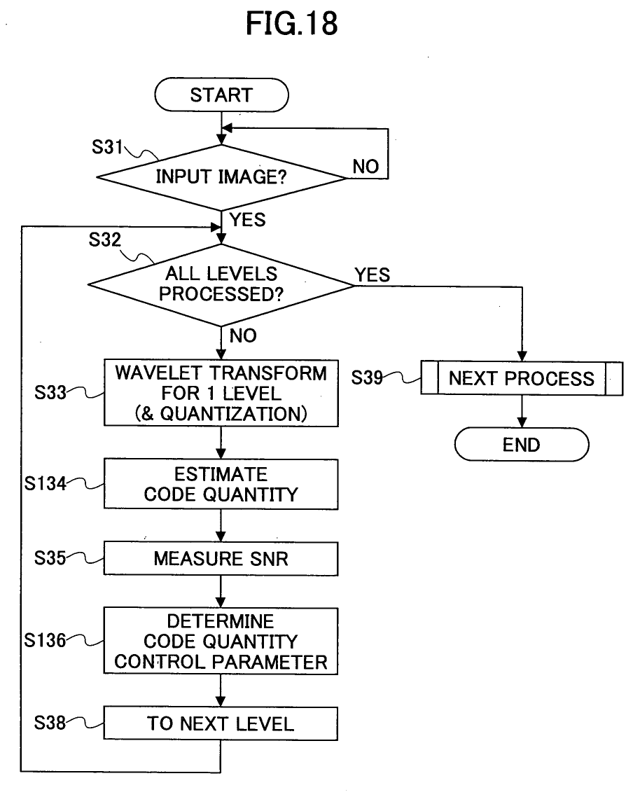

Next, a description will be given of another embodiment of the image processing apparatus according to the present invention, by referring to FIG. 18. FIG. 18 is a flow chart for illustrating an image processing operation of this embodiment of the image processing apparatus. This embodiment of the image processing apparatus employs another embodiment of the computer-readable storage medium according to the present invention. In this embodiment, the present invention is also applied to the composite apparatus 1 shown in FIGS. 7 and 8. Furthermore, this embodiment utilizes the JPEG2000 algorithm.

The basic structure of this embodiment of the image processing apparatus is the same as that of the embodiment described above, except that the image processing operation that is performed by the CPU 30 of the composite apparatus 1 based on one or a plurality of programs is different from that of the embodiment described above.

A description will be given of the image processing operation which is performed by the CPU 30 of the composite apparatus 1 based on one or a plurality of programs, to store the image data as an image server.

In FIG. 18, those steps that are the same as those corresponding steps in FIG. 14 are designated by the same reference numerals, and a description thereof will be omitted. In this embodiment, the step S37 shown in FIG. 14 is not provided, and steps S134 and S136 are provided in place of the steps S34 and S36, as shown in FIG. 18. When not carrying out the coding, it is not possible to obtain an accurate code quantity. For this reason, the step S134 makes an estimate for a case where each bit plane is truncated, in order to obtain an estimated quantity of the code quantity. More particularly, the code quantity is estimated using values in a table that stores information indicating the code quantity with respect to each number of bits reduced, based on past statistical data, for example. Since the code quantity is controlled using the estimated quantity, the step S136 determines the code quantity control parameter based on the estimated quantity, and truncates the present sub-band by obtaining the bit-plane to be truncated.

For example, a table of truncating bit-plane versus code quantity obtained from the rule of thumb may be prepared in advance, and a bit-plane value may be substituted into this table, in order to obtain the estimated quantity of the code quantity. The estimated quantity may be obtained using only a fixed table or, corrected using actually measured values obtained when coding the immediately preceding tile. In the latter case, the correcting method is not limited to a particular method. For example, the correcting method may be a method that uses the values of the immediately preceding tile as they are or, a method that uses an average of the values of the immediately preceding tile and the values of the table.

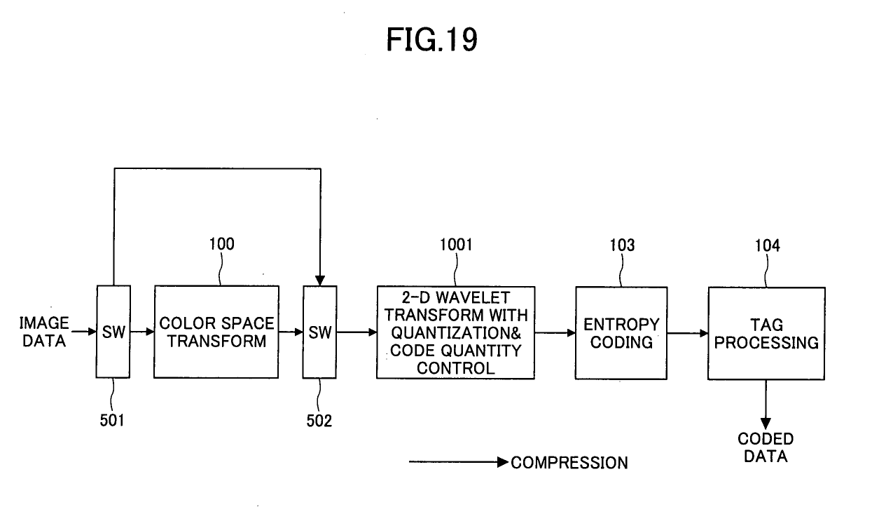

A description will be given of another embodiment of the present invention, by referring to FIG. 19. FIG. 19 is a functional block diagram for illustrating an image processing system of this embodiment of the image processing apparatus according to the present invention. In FIG. 19, those units that are the same as those corresponding units in FIGS. 1 and 15 are designated by the same reference numerals, and a description thereof will be omitted.

The basic structure of the image processing apparatus of this embodiment is the same as that of the embodiment described above, except that the image processing operation which is carried out by the CPU 30 of the composite apparatus 1 based on one or a plurality of programs is different from that of the embodiment described above.

A description will be given of the image processing operation which is carried out by the CPU 30 of the composite apparatus 1 based on one or a plurality of programs, to store the image data as an image server. This embodiment carries out a process similar to those of the embodiments described above in conjunction with FIGS. 17 and 18. For this reason, in place of the two-dimensional wavelet transform unit 101 and the quantization unit 402 shown in FIG. 15, a two-dimensional wavelet transform with quantization and code quantity control unit 1001 is provided in this embodiment as shown in FIG. 19. The two-dimensional wavelet transform with quantization and code quantity control unit 1001 determines the code quantity control parameter based on the estimated quantity of the code quantity, and truncates the present sub-band by obtaining the bit-plane to be truncated, in order to perform a quantization while making the two-dimensional wavelet transform.

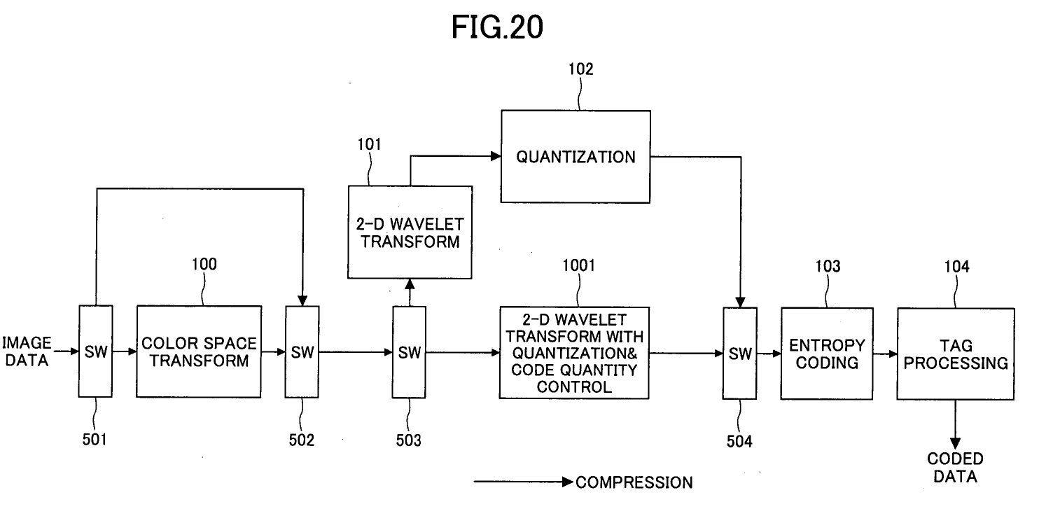

A description will be given of another embodiment of the present invention, by referring to FIG. 20. FIG. 20 is a functional block diagram for illustrating an image processing system of this embodiment of the image processing apparatus according to the present invention. In FIG. 20, those units that are the same as those corresponding units in FIGS. 1 and 16 are designated by the same reference numerals, and a description thereof will be omitted.

The basic structure of the image processing apparatus of another embodiment is the same as that of the embodiment described above, except that the image processing operation that is performed by the CPU 30 of the composite apparatus 1 based on one or a plurality of programs is different from that of the embodiment described above.

A description will be given of the image processing operation that is performed by the CPU 30 of the composite apparatus 1 based on one or a plurality of programs, to store the image data as an image server. This embodiment carries out a process similar to those of the embodiments described above in conjunction with FIGS. 17 and 18. For this reason, the two-dimensional wavelet transform unit 101 is provided between the switch 503 and the quantization unit 102, and in place of the quantization unit 402 shown in FIG. 16, a two-dimensional wavelet transform with quantization and code quantity control unit 1001 is provided in this embodiment as shown in FIG. 19. The two-dimensional wavelet transform with quantization and code quantity control unit 1001 determines the code quantity control parameter based on the estimated quantity of the code quantity, and truncates the present sub-band by obtaining the bit-plane to be truncated, in order to perform a quantization while making the two-dimensional wavelet transform.

In each of the embodiments described heretofore, the image processing operation of each embodiment is performed with respect to the document image which is read by the scanner 2, however, the image processing operation is not limited to such. For example, the image processing operation of each embodiment may be performed with respect to an original image (image data) that is received via a network.

In addition, in each of the embodiments, the code quantity of the sub-band is controlled by the quantizing method when performing the coding, but the code quantity control is not limited to such. For example, the code quantity of the sub-band may be controlled by the bit deleting method or the like after the coding and before carrying out another process.

Moreover, the composite apparatus 1 is used as the image processing apparatus in each of the described embodiments. However, the image processing apparatus is not limited to the composite apparatus 1, and a personal computer or the like may also be used as the image processing apparatus. In this case, the personal computer may include a CPU, a ROM, a RAM, a Hard Disk Drive (HDD) for storing various programs, a CD-ROM drive, a scanner, a communication control unit (CCU) for exchanging information by communicating with an external apparatus via a network, a display unit for displaying processes, results and the like, and an input device such as a keyboard and a mouse. The HDD in this case functions as a computer-readable storage medium that stores one or a plurality of programs associated with the image processing operation.

Generally, the program that is installed in the HDD of the personal computer is stored in optical recording media such as CD-ROM and DVD-ROM, magneto-optical recording media such as magneto-optical disk, and magnetic recording media such as floppy disk (FD). In other words, the program that is recorded in such a recording medium is installed in the HDD. For this reason, the portable storage media such as the optical recording media such as the CD-ROM, the magnetic recording media such as the floppy disk, and the like, may also form the computer-readable storage medium which stores the program associated with the image processing operation. In addition, the program may be read via a communication control unit and installed in the HDD.

Further, the present invention is not limited to these embodiments, but various variations and modifications may be made without departing from the scope of the present invention.

What is claimed is

1. An image processing apparatus comprising:
a converting unit to subject an image data to a hierarchical two-dimensional wavelet transform;
a coding unit to code each of a plurality of sub-bands which are hierarchically generated from the image data by the converting unit; and
a code quality control unit to control, based on a code quantity of a predetermined sub-band, code quantities of other sub-bands.

2. The image processing apparatus as claimed in claim 1, wherein:
the coding unit codes each of the plurality of sub-bands based on a predetermined code quantity control parameter; and
the code quantity control unit controls the code quantities of the other sub-bands by changing the code quantity control parameter based on the code quantity of the predetermined sub-band.

3. The image processing apparatus as claimed in claim 1, wherein the code quantity control unit controls a code quantity of a sub-band in a lower layer of a hierarchical structure based on a code quantity of a sub-band in an upper layer of the hierarchical structure.

4. The image processing apparatus as claimed in claim 1, wherein the code quantity control unit controls a code quantity of a sub-band in a predetermined layer of a hierarchical structure based on the code quantity of the predetermined sub-band that is also in the predetermined layer of the hierarchical structure.

5. The image processing apparatus as claimed in claim 1, further comprising:
a reading optical system to optically read the image data from a document.

6. The image processing apparatus as claimed in claim 1, further comprising:
an expanding unit to expand the image data that is coded by a procedure including a decoding and a two-dimensional inverse wavelet transform.

7. The image processing apparatus as claimed in claim 6, further comprising:
a printer engine to form an image on a recording medium based on the image data that has been expanded by the expanding unit.

8. The image processing apparatus as claimed in claim 1, wherein the code quantity control unit controls the code quantity after the wavelet transform with respect to all layers of the hierarchical structure.

9. The image processing apparatus as claimed in claim 1, wherein the code quantity control unit controls the code quantity after the wavelet transform with respect to each layer of the hierarchical structure.

10. An image processing apparatus comprising:
converting means for subjecting an image data to a hierarchical two-dimensional wavelet transform;
coding means for coding each of a plurality of sub-bands which are hierarchically generated from the image data by the converting means; and
code quantity control means for controlling, based on a code quantity of a predetermined sub-band, code quantities of other sub-bands.

11. An image processing apparatus comprising:
a converting unit to subject an image data to a hierarchical two-dimensional wavelet transform;
a first coding unit to code each of a plurality of sub-bands that are hierarchically generated from the image data by the converting unit, based on a predetermined code quantity;
a code quantity control unit to control, based on a code quantity of an arbitrary sub-band, code quantities of other sub-bands;
a second coding unit to code each of the plurality of sub-bands which are hierarchically generated from the image data by the converting unit, based on the code quantity which is controlled by the code quantity control unit; and
a switching unit to selectively supply the plurality of sub-bands from the converting unit to one of the first and second coding units.

12. An image processing apparatus comprising:
converting means for subjecting an image data to a hierarchical two-dimensional wavelet transform;
first coding means for coding each of a plurality of sub-bands that are hierarchically generated from the image data by the converting means, based on a predetermined code quantity;
code quantity control means for controlling, based on a code quantity of an arbitrary sub-band, code quantities of other sub-bands;
second coding means for coding each of the plurality of sub-bands which are hierarchically generated from the image data by the converting means, based on the code quantity which is controlled by the code quantity control means; and
switching means for selectively supplying the plurality of sub-bands from the converting means to one of the first and second coding means.

13. An article of manufacture comprising one or more recordable media having instructions stored thereon which, when executed by a computer, cause the computer to process image data according to a method comprising:
subjecting an image data to a hierarchical two-dimensional wavelet transform;
coding each of a plurality of sub-bands which are hierarchically generated from the image data; and
controlling, based on a code quantity of a predetermined sub-band, code quantities of other sub-bands.

14. The article of manufacture as claimed in claim 13, wherein:
coding each of the plurality of sub-bands causes the computer to code each of the plurality of sub-bands based on a predetermined code quantity control parameter; and
controlling code quantities comprises causing the computer to control the code quantities of the other sub-bands by changing the code quantity control parameter based on the code quantity of the predetermined sub-band.

15. The article of manufacture as claimed in claim 13, wherein controlling code quantities comprises causing the computer to control a code quantity of a sub-band in a lower layer of a hierarchical structure based on a code quantity of a sub-band in an upper layer of the hierarchical structure.

16. The article of manufacture as claimed in claim 13, wherein controlling code quantities comprises causing the computer to control a code quantity of a sub-band in a predetermined layer of a hierarchical structure based on the code quantity of the predetermined sub-band which is also in the predetermined layer of the hierarchical structure.

17. The article of manufacture as claimed in claim 13, further comprising:
causing the computer to expand the image data that is coded by a procedure including a decoding and a two-dimensional inverse wavelet transform.

18. The article of manufacture as claimed in claim 13, wherein controlling code quantities comprises causing the computer to control the code quantity after the wavelet transform with respect to all layers of the hierarchical structure.

19. The article of manufacture as claimed in claim 13, wherein controlling code quantities comprises causing the computer to control the code quantity after the wavelet transform with respect to each layer of the hierarchical structure.

20. An article of manufacture comprising one or more recordable media having instructions stored thereon which, when executed by a computer, cause the computer to process image data according to a method comprising:
subjecting an image data to a hierarchical two-dimensional wavelet transform;
coding each of a plurality of sub-bands that are hierarchically generated from the image data, based on a predetermined code quantity;
controlling, based on a code quantity of an arbitrary sub-band, code quantities of other sub-bands;
coding each of the plurality of sub-bands which are hierarchically generated from the image data by the converting procedure, based on the code quantity; and
selectively supplying the plurality of sub-bands for use by one of the first and second coding procedures.
